(19) United States
(12) Patent Application Publication
(10) Pub. No.: US 2026/0136331 A1
(43) Pub. Date: May 14, 2026

(54) METHOD AND DEVICE FOR WIRELESS COMMUNICATION

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/390,447

(22) Filed: Nov. 14, 2025

Related U.S. Application Data
(63) Continuation of application No. PCT/CN2024/102068, filed on Jun. 27, 2024.

(51) Int. Cl. H04W 72/04; H04W 28/26

(52) U.S. Cl. CPC H04W 72/04; H04W 28/26

(57) ABSTRACT

A method and device for wireless communications are provided. Oe example method includes: transmitting, by a first terminal device in a non-terrestrial network (NTN) cell, a first early data transmission (EDT) on a first resource; and receiving, by the first terminal device, a feedback message of the first EDT from a network device, the feedback message of the first EDT including a first radio network temporary identifier (RNTI), wherein the first resource is one of a plurality of common preconfigured uplink resources (PUR), the plurality of common PURs correspond to a plurality of RNTIs including the first RNTI, and the first RNTI corresponds to the first resource or the first EDT includes the first RNTI.

### CROSS-REFERENCE TO RELATED APPLICATIONS

This application is a continuation of International Application No. PCT/CN2024/102068, filed on Jun. 27, 2024, the disclosure of which is hereby incorporated by reference in its entirety.

### TECHNICAL FIELD

The present application relates to the technical field of communication, and more specifically, to a method and device for wireless communication.

### BACKGROUND

In order to reduce signaling overhead and power consumption, terminal devices in idle state can directly perform early data transmission (EDT) via preconfigured uplink resources (PUR), without relying on the random access channel (RACH) to perform random access procedures. For example, in a non-terrestrial network (NTN) system, multiple terminal devices can perform RACH-less EDT via PUR.

However, NTN cells face issues such as large coverage areas and prolonged propagation delays. In such scenarios, how terminal devices can more efficiently perform RACH-less EDT has become a technical issue that needs to be addressed.

### SUMMARY

The present application provides a method and device for wireless communication. Various aspects involved in the embodiments of the present application are introduced in the following.

According to a first aspect of the present application, there is provided a method for wireless communication including: transmitting, by a first terminal device, a first message on a first resource, the first message being used to request a first EDT; and receiving, by the first terminal device, a feedback message of the first EDT sent by a network device, the feedback message of the first EDT including a first radio network temporary identifier (RNTI); where the first resource is one of multiple common PURs, the multiple common PURs correspond to multiple RNTIs including the first RNTI, and the first RNTI corresponds to the first resource or the first message includes the first RNTI.

According to a second aspect of the present application, there is provided another method for wireless communication including: receiving, by a network device, a first message on a first resource, the first message being used by a first terminal device to request a first EDT; and sending, by the network device, a feedback message of the first EDT to the first terminal device, the feedback message of the first EDT including a first RNTI; where the first resource is one of multiple common PURs, the multiple common PURs correspond to multiple RNTIs including the first RNTI, and the first RNTI is either an RNTI corresponding to the first resource or an RNTI included in the first message.

According to a third aspect of the present application, there is provided a device for wireless communication, where the device is a first terminal device, and the first terminal device includes: a transmitting unit configured to transmit a first message on a first resource, the first message being used to request a first EDT; and a receiving unit configured to receive a feedback message of the first EDT sent by a network device, the feedback message of the first EDT including a first RNTI; where the first resource is one of multiple common PURs, the multiple common PURs correspond to multiple RNTIs including the first RNTI, and the first RNTI corresponds to the first resource or the first message includes the first RNTI.

According to a fourth aspect of the present application, there is provided a device for wireless communication, where the device is a network device, and the network device includes: a receiving unit configured to receive a first message on a first resource, the first message being used by a first terminal device to request a first EDT; and a transmitting unit configured to send a feedback message of the first EDT to the first terminal device, the feedback message of the first EDT including a first RNTI; where the first resource is one of multiple common PURs, the multiple common PURs correspond to multiple RNTIs including the first RNTI, and the first RNTI is either an RNTI corresponding to the first resource or an RNTI included in the first message.

In a fifth aspect, a communication device is provided, which includes a memory and a processor, where the memory is configured to store a program, and the processor is configured to call the program in the memory to implement the method according to the first or second aspect.

In a sixth aspect, a device is provided, which includes a processor for calling a program from a memory to implement the method according to the first or second aspect.

In a seventh aspect, a chip is provided, which includes a processor for calling a program from a memory, such that a device equipped with the chip executes the method according to the first or second aspect.

In an eighth aspect, a computer-readable storage medium is provided, on which a program is stored, where the program enables a computer to implement the method according to the first or second aspect.

In a ninth aspect, a computer program product is provided, comprising a program that enables a computer to implement the method according to the first or second aspect.

In a tenth aspect, a computer program is provided, which enables a computer to implement the method according to the first or second aspect.

In embodiments of the present application, a first terminal device requests a first EDT via a first message transmitted on a first resource determined in a contention-based approach. The first resource corresponds to a first RNTI, or the first message includes the first RNTI. A feedback message sent by a network device indicating whether the first EDT succeeded may include the first RNTI. Through this mechanism, the network device can determine both the first resource selected by the first terminal device and its access request based on the first RNTI, and subsequently provide feedback regarding the first EDT, thereby reducing collisions among terminal devices.

### BRIEF DESCRIPTION OF THE DRAWINGS

FIG. 1 shows a wireless communication system to which the embodiments of the present application are applied.

FIG. 2 is a schematic flow chart of RACH-less EDT.

FIG. 3 is a schematic flowchart of a method for wireless communication provided in the embodiments of the present application.

FIG. 4 is a schematic flowchart of a possible implementation of the method shown in FIG. 3.

FIG. 5 is a schematic flowchart of another possible implementation of the method shown in FIG. 3.

FIG. 6 is a schematic diagram of an information structure of a signaling group.

FIG. 7 is a schematic flowchart of another method for wireless communication provided in the embodiments of the present application.

FIG. 8 is a schematic flowchart of a possible implementation of the method shown in FIG. 7.

FIG. 9 is a schematic block diagram of a device for wireless communication provided in the embodiments of the present application.

FIG. 10 is a schematic block diagram of another device for wireless communication provided in the embodiments of the present application.

FIG. 11 is a schematic block diagram of a communication device provided in the embodiments of the present application.

### DETAILED DESCRIPTION OF THE EMBODIMENTS

The technical solutions in the embodiments of the present application are described hereinafter in conjunction with the drawings in the embodiments of the present application. Apparently, the described embodiments are only a part of the embodiments of the present application, rather than all embodiments. For the embodiments described in the present application, all other embodiments obtained by those of ordinary skill in the art without creative efforts fall within the scope of protection of the present application.

The embodiments of the present application can be applied to various communication systems, such as: global system of mobile communication (GSM) systems, code division multiple access (CDMA) systems, wide band code division multiple access (WCDMA) systems, general packet radio service (GPRS), long term evolution (LTE) systems, advanced long term evolution (LTE-A) systems, new radio (NR) systems, evolved NR systems, LTE-based access to unlicensed spectrum (LTE-U) systems, NR-based access to unlicensed spectrum (NR-U) systems, universal mobile telecommunication system (UMTS), wireless local area networks (WLAN), wireless fidelity (WiFi), and 5th-generation (5G) communication systems. The embodiments of the present application can also be applied to other communication systems, such as future communication systems. The future communication systems may be, for example, 6th-generation (6G) mobile communication systems, or satellite communication systems.

Conventional communication systems support a limited number of connections and are easy to implement. However, with the development of communication technology, communication systems can not only support conventional cellular communication but also support one or more other types of communication. For example, a communication system can support one or more of the following types of communication: device to device (D2D) communication, machine to machine (M2M) communication, machine type communication (MTC), enhanced MTC (eMTC), vehicle to vehicle (V2V) communication, and vehicle to everything (V2X) communication. The embodiments of the present application can also be applied in communication systems supporting the aforementioned communication modes.

The communication system in the embodiments of the present application can be applied to carrier aggregation (CA) scenarios, dual connectivity (DC) scenarios, and standalone (SA) networking scenarios.

The communication system in the embodiments of the present application can be applied to unlicensed spectrum. The unlicensed spectrum may be considered as shared spectrum. Alternatively, the communication system in the embodiments of the present application can also be applied to licensed spectrum. The licensed spectrum may be considered as dedicated spectrum.

The embodiments of the present application can be applied to non-terrestrial network (NTN) systems. As an example, the NTN systems may be 4G-based NTN systems, NR-based NTN systems, internet of things (IoT)-based NTN systems, and narrow band internet of things (NB-IoT)-based NTN systems.

The communication system may include one or more terminal devices. The terminal device mentioned in the embodiments of the present application may also be referred to as user equipment (UE), access terminal, user unit, user station, mobile platform, mobile station (MS), mobile terminal (MT), remote station, remote terminal, mobile device, user terminal, terminal, wireless communication device, user agent or user device.

In some embodiments, the terminal device may be a station (ST) in WLAN. In some embodiments, the terminal device may be a cellular phone, cordless phone, session initiation protocol (SIP) phone, wireless local loop (WLL) station, personal digital assistant (PDA) device, handheld device with wireless communication function, computing device, or other processing device connected to a wireless modem, in-vehicle device, wearable device, terminal device in a next-generation communication system (such as NR system), or terminal device in a future-evolved public land mobile network (PLMN), etc.

In some embodiments, the terminal device may refer to a device that provides voice and/or data connectivity to a user. For example, the terminal device may be a handheld device or an in-vehicle device with wireless connectivity. As some specific examples, the terminal device may be mobile phones, tablets, laptops, palmtop computers, mobile internet devices (MID), wearable devices, virtual reality (VR) devices, augmented reality (AR) devices, wireless terminals in industrial control, wireless terminals in self-driving, wireless terminals in remote medical surgery, wireless terminals in smart grid, wireless terminals in transportation safety, wireless terminals in smart city, wireless terminals in smart home, etc.

In some embodiments, the terminal device may be deployed on land. For example, the terminal device may be deployed indoors or outdoors. In some embodiments, the terminal device may be deployed on the water surface, such as on a ship. In some embodiments, the terminal device may be deployed in the air, such as on airplanes, balloons, and satellites.

In addition to the terminal device, the communication system may further include one or more network devices. The network device in the embodiments of the present application may be a device configured for communication with the terminal device. The network device may also be referred to as an access network device or a radio access network device. For example, the network device may be a base station. The network device in the embodiments of the present application may refer to a radio access network (RAN) node (or device) that connects a terminal device to a radio network. The base station may broadly cover or be replaced with the following various names, such as: NodeB, evolved NodeB (eNB), next generation NodeB (gNB), relay station, access point (AP), transmitting and receiving point (TRP), transmitting point (TP), master eNB (MeNB), secondary eNB (SeNB), multi-standard radio (MSR) node, home base station, network controller, access node, wireless node, transmission node, transceiver node, base band unit (BBU), remote radio unit (RRU), active antenna unit (AAU), remote radio head (RRH), central unit (CU), distributed unit (DU), positioning node, etc. The base station may be a macro base station, a micro base station, a relay node, a donor node, or the like, or a combination thereof. The base station may also refer to a communication module, modem, or chip configured to be installed within the aforementioned equipment or devices. The base station may also be a mobile switching center, a device that performs base station functions in D2D, V2X, and M2M communication, a network side device in 6G network, or a device that performs base station functions in future communication systems. The base station can support networks of the same or different access technologies. The embodiments of the present application impose no limitation on the specific technology and device form adopted by the network device.

The base station may be fixed or mobile. For example, a helicopters or drone can be configured to act as a mobile base station, and one or more cells can move according to the location of the mobile base station. In other examples, a helicopter or drone can be configured as a device for communication with another base station.

In some deployments, the network device in the embodiments of the present application may refer to CU or DU, or the network device includes CU and DU. gNB may also include AAU.

By way of example and not limitation, in the embodiments of the present application, the network device may have mobility characteristics. For example, the network device may be a mobile device. In some embodiments of the present application, the network device may be a satellite or a balloon station. In some embodiments of the present application, the network device may also be a base station located on land, in water, or at other locations.

In the embodiments of the present application, the network device jay provide services for a cell, and the terminal device communicates with the network device through the transmission resources (such as frequency domain resources, or spectrum resources) used by the cell. The cell may be the cell corresponding to the network device (such as a base station), and the cell may belong to a macro base station or a base station corresponding to a small cell. The cell herein may include: metro cells, micro cells, pico cells, femto cells, etc. These small cells are characterized by their small coverage areas and low transmit power, making them suitable for providing high-speed data transmission services.

Illustratively, FIG. 1 is a schematic diagram of the architecture of a communication system provided in the embodiments of the present application. As shown in FIG. 1, a communication system 100 may include a network device 110 which may be a device that communicates with terminal devices 120 (also known as a communication terminal or terminal). The network device 110 can provide communication coverage for specific geographic areas and can communicate with the terminal devices located within this coverage area.

FIG. 1 illustrates one network device and two terminal devices by way of example. In some embodiments of the present application, the wireless communication system 100 may include multiple network devices and each network device's coverage area may include other numbers of terminal devices, which is not limited herein.

In the embodiments of the present application, the communication system shown in FIG. 1 may further include other network entities such as a mobility management entity (MME) and an access and mobility management function (AMF), which is not limited in the embodiments of the present application.

It should be understood that, devices with communication functions in the network/system of the embodiments of the present application can be referred to as communication devices. Taking the communication system 100 shown in FIG. 1 as an example, the communication devices may include the network device 110 and the terminal device 120 with communication functions. The network device 110 and the terminal device 120 may be the specific devices mentioned above, which will not be further described herein. The communication devices may also include other devices in the communication system 100, such as network controllers, mobility management entities, and other network entities, which is not limited in the embodiments of the present application.

To facilitate understanding, some relevant technical knowledge related to the embodiments of the present application is firstly introduced. The following related technologies can be freely combined with the technical solutions of the embodiments of the present application as optional solutions, and all these combinations fall within the scope of protection of the embodiments of the present application. The embodiments of the present application include at least some of the following contents.

Reducing signaling overhead and power consumption has always been an important research topic in the development of communication technology. For example, in Release 15 (Rel-15) of the 3rd Generation Partnership Project (3GPP), EDT feature was introduced for NB IoT and eMTC systems. The EDT feature enables terminal devices in radio resource control (RRC) idle (IDLE) mode to directly transmit data via message 3 (MSG 3) during random access. That is to say, terminal devices can transmit data without transitioning from RRC IDLE mode to RRC CONNECTED mode, thereby reducing signaling overhead and power consumption for related communication equipment. For example, in Rel-16, the early transmission of uplink (UL) data was further enhanced by introducing the PUR mechanism. The PUR mechanism allows the eNB to configure dedicated uplink resources for terminal devices. The uplink resource is, for example, a physical uplink shared channel (PUSCH) resource.

In some embodiments, EDT can be applied to a four-step random access process. Specifically, terminal devices and network devices can complete the four-step EDT-based random access process via message 1 (Msg1) to message 4 (Msg4). By way of example, terminal devices and network devices transmit EDT specific message 1, random access response (RAR), RRC early data request (RRCEarlyDataRequest) message (Msg3), and RRC early data complete (RRCEarlyDataComplete) message (Msg4).

In some embodiments, terminal devices in idle mode can use PUR configured by network devices to transmit UL data without performing the random access process. For example, the terminal device can directly transmit the RRCEarlyDataRequest message and receive the RRCEarlyDataComplete message, that is, transmit Msg3 and Msg4. By omitting the transmission of Msg1 and RAR in the random access process, this approach enhances uplink transmission efficiency and further reduces the terminal device's power consumption.

In the above embodiments, EDT without performing the random access process may also be referred to as RACH-less EDT. The RACH-less EDT in the embodiments of the present application can be applied to both NTN cells and terrestrial network (TN) cells. Compared to applications in TN, introducing RACH-less EDT enhancement in NTN is more meaningful.

Firstly, compared to TN cells, NTN cells have much larger coverage areas. For example, IoT-enabled NTNs must support massive terminal device capacity. Furthermore, NTNs typically involve significantly prolonged round trip times (RTT). Therefore, the cost of restarting the entire RACH process in NTN is prohibitively high. After introducing RACH-less EDT, Msg3 can be directly transmitted without Msg1/Msg2, which can effectively save signaling overhead caused by Msg1/Msg2.

Secondly, terminal devices typically possess Global Navigation Satellite System (GNSS) capabilities, meaning that a terminal device is aware of its location before accessing NTN cells. In addition, the terminal device can also be aware of the location of the satellite. For example, the terminal device can determine the location of the satellite based on the ephemeris information broadcasted in the system information blocks (SIB). Based on the locations of the terminal device and the satellite, the terminal device can determine a valid timing advance (TA). When the terminal device possesses a valid timing alignment value, RACH-less EDT can be enabled.

In summary, achieving access via RACH-less EDT in NTN systems can effectively reduce signaling overhead and power consumption.

There are certain requirements for the application scenarios and initiation conditions of RACH-less EDT. In other words, terminal devices in a cell that meet the conditions can enable RACH-less EDT to reduce signaling overhead. In some embodiments, application scenarios for RACH-less EDT may include establishing or resuming an RRC connection upon upper layer request, or initiating an establishment or resumption request for initial calls. In some embodiments, the initiation conditions for RACH-less EDT include: the terminal device possesses a valid timing alignment value, and/or the size of the media access control (MAC) protocol data unit (PDU) obtained at the MAC layer is not expected to exceed the transport block size (TBS) configured by the system for RACH-less EDT. The initiation of RACH-less EDT requires to meet at least the above conditions.

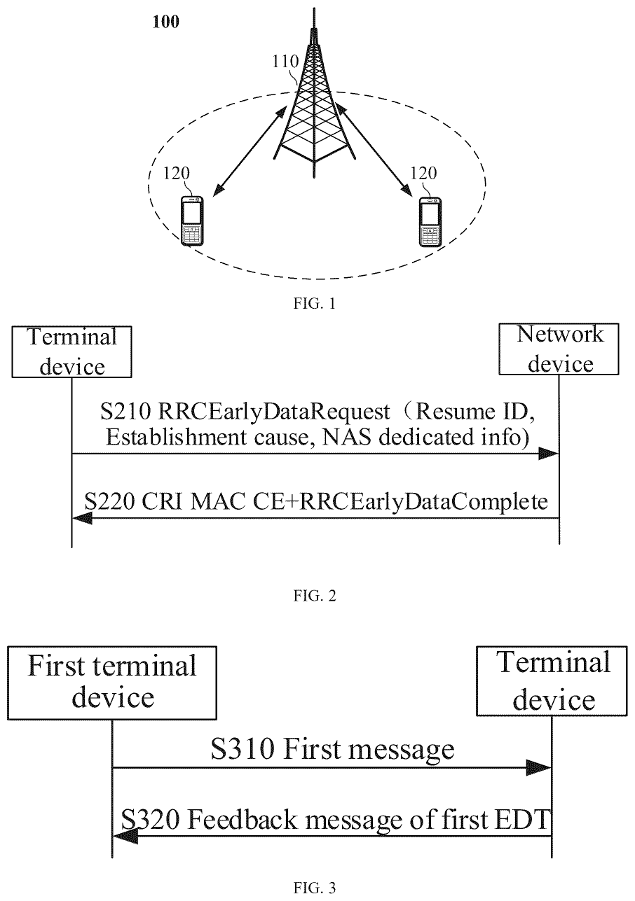

For ease of understanding, the following provides an exemplary illustration of RACH-less EDT process in conjunction with FIG. 2. FIG. 2 illustrates from a perspective of interaction between a terminal device and a network device. The terminal device may be a UE, and the network device may be a network side device of an NTN.

Referring to FIG. 2, in step S210, the terminal device transmits RRCEarlyDataRequest information to the network device. The RRCEarlyDataRequest information usually includes resume identity (ID), establishment cause, and dedicated information for non-access stratum (dedicatedinfoNAS).

In step S220, the network device feedbacks RRC EarlyDataComplete to the terminal device via the MAC control element (MAC CE) carrying channel state information reference signal resource indicator (CSI-RS RI, CRI).

The preceding section introduced the RACH-less EDT process in conjunction with FIG. 2. In actual communication systems, if a terminal device is configured with PUR but does not need to initiate the PUR process, the preconfigured uplink resources will be wasted. In NTN systems, this issue is more pronounced. Massive terminal devices are encompassed in an NTN cell, making it impractical to allocate dedicated uplink resources for all terminal devices. If uplink resources are preconfigured but a large number of terminal devices fail to perform uplink transmission, significant waste would occur. To address this issue, multiple terminal devices may share uplink resources. As an example, PUR may be implemented as shared common resources. For example, multiple terminal devices initiating RACH-less EDT can transmit Msg3 on shared uplink resources to improve resource utilization efficiency and capacity.

However, sharing uplink resources for Msg3 transmission may increase the risk of collisions among different terminal devices. For example, multiple terminal devices may attempt RACH-less EDT and use the same time-frequency resources to simultaneously transmit Msg3. If the collision rate is high, it will consequently lead to adverse effects, such as increased signaling overhead and terminal device power consumption. However, in NTNs, especially NB-IoT over NTN, spectrum (also termed frequency resources) is scarce and costly. Therefore, in these scenarios, effective designs and/or specifications for RACH-less EDT involving Msg3 transmission without Msg1 are crucial.

In conclusion, in scenarios such as NTN, it is worth studying how terminal devices can perform RACH-less EDT more efficiently.

It should be noted that the above issue of collision in the use of shared resources of EDT due to prolonged propagation delay and massive terminal devices in NTN systems is only an example. The embodiments of the present application can be applied to any type of communication scenario where EDT shared resources come into collision.

Based on this, the embodiments of the present application propose a method for wireless communication. In this method, a first terminal device can transmit a first message on a first resource to request a first EDT. During the communication process, the network device and the first terminal device can determine a first RNTI pertinent to the first terminal device based on configuration or first resource-related information. The first RNTI can be used to identify the first terminal device and the first message transmitted by the first terminal device. By leveraging distinct RNTIs, multiple terminal devices can share multiple common PURs including the first resource.

In some embodiments, the first EDT may include the transmission of uplink data or information when the first terminal device is in an idle state. For example, the first EDT may be replaced with a first RACH-less EDT.

As an example, the first EDT can be used to transmit TA update messages.

As an example, the first EDT can be initiated for data transmission or voice call, which is not limited herein.

As an example, multiple TBSs corresponding to the first EDT can be used to transmit uplink data of different sizes.

As an example, the first EDT may be an NTN RACH-less EDT. For example, when supporting NTN RACH-less EDT, communication devices can use preconfigured orthogonal cover code (OCC) narrowband physical random access channel (NPRACH) resources to skip Msg1 and Msg2.

In the embodiments of the present application, ‘request first EDT’ can be replaced with ‘perform first EDT’, or ‘request access via first EDT’. That is to say, the first terminal device can request the first EDT by directly performing the first EDT. In other words, the first message may be used by the first terminal device to request access. Requesting access may also be referred to as requesting RRC connection.

In some embodiments, the first terminal device may request the first EDT via the first message, or may directly perform the first EDT via the first message. In the case that the first terminal device requests the first EDT via the first message, the first message may contain request information of the first EDT. In the case that the first terminal device performs the first EDT via the first message, the first message may contain the data to be transmitted corresponding to the first EDT.

In some embodiments, the first terminal device may request the first EDT and perform the first EDT at the same time. That is to say, the first message may contain request information and the data to be transmitted corresponding to EDT.

The first resource is one of multiple common PURs. Multiple common PURs refer to the PURs configured by the network device that can be shared as common resources. As mentioned earlier, configuring PUR as uplink resources shared by multiple terminal devices can avoid wastage of resources. In some scenarios, PUR is mainly used for PUSCH transmission. Therefore, PUR may also be referred to as PUSCH resources. That is to say, multiple common PURs may be PUSCH resources concurrently accessible by multiple terminal devices.

In some embodiments, multiple common PURs may be all or part of the time-frequency resources in a preconfigured resource pool, or may be time-frequency resources in multiple preconfigured resource pools, which is not limited herein. For example, multiple common PURs at least include time-frequency resources.

As an example, multiple preconfigured common PURs may be configured for each cell and shared by multiple terminal devices.

As an example, multiple common PURs may also be PURs for physical random access channel (PRACH). For example, for RACH-less EDT that supports NTN, PUSCH resources corresponding to PRACH can be used.

In some embodiments, multiple common PURs can be configured based on the number of terminal devices within the cell, or based on the number of terminal devices that transmit requests, or based on the size of uplink resources.

In some embodiments, the network device may indicate multiple common PURs to terminal devices based on multiple methods. Optionally, the network device may actively send configuration information of multiple common PURs, or indicate configuration information of multiple common PURs based on requests from terminal devices.

As an example, the network device may provide multiple common PURs and/or configuration information of multiple common PURs via SIB. For example, the broadcast channel in SIB can be used to broadcast configuration information of multiple common PURs.

As an example, the network side may send multiple common PURs and/or configuration information of multiple common PURs via RRC dedicated signaling (also known as dedicated signaling). RRC dedicated signaling may be, for example, the RRCConnectionRelease message.

As an example, the network devices may broadcast the configuration of multiple common PURs in SIB, or use RRCrelease to configure multiple common PURs. As an example, the network device may broadcast multiple common PURs in SIB and configure other information in RRCRelease. Other information includes, for example, TA timer (TAT), TA, cell RNTI (C-RNTI), RRC messages, and other downlink (DL) data.

As an example, when the terminal device initially accesses the network, if the random access is successful, the indices of multiple common PURs of EDT may be carried in SIB messages, or RRC messages during the random access process, or DCI information.

As an example, the network devices may send multiple common PURs and resource configuration information based on requests from terminal devices. For example, in an NTN system, the first terminal device can trigger a resource configuration request to request the NTN to provide configuration information of multiple common PURs.

In some embodiments, the configuration of multiple common PURs is applicable to the serving cell where the first terminal device is located and/or neighboring cell. In some scenarios, although PURs are shared, they still need to be specific to terminal devices or cells. In an NTN system, once the serving satellite moves out of the current service region and a new satellite takes over, the PUR configuration does not work anymore. Based on this, the configuration of multiple common PURs may be applicable across multiple cells, thereby avoiding terminal devices from entering RRC connected mode to acquire the configuration in each new cell.

As an example, the configuration of multiple common PURs is applicable to serving cells that provide PUR configurations.

As an example, the configuration of multiple common PURs is applicable to serving cells that provide PUR configurations as well as other cells.

As an example, multiple common PURs are located in a PUR shared resource pool, or multiple common PURs form a PUR shared resource pool.

In some embodiments, multiple common PURs may allow for periodic occurrences. That is to say, the resource size of multiple common PURs may be repetitive, especially when these multiple common PURs are configured within SIB. Specifically, if the network side provides multiple common PURs with repetition sizes, it is necessary to configure the corresponding conditions for terminal devices to select among multiple common PURs.

In some embodiments, if configurations for multiple common PURs are provided in system information, the solution in the embodiments of the present application is effective for all types of terminal devices including terminal devices accessing the network for the first time.

In some embodiments, the terminal device may select the uplink resource for requesting or performing the first EDT through multiple approaches. For example, the first terminal device may determine the corresponding first resource based on the configuration of the network device. In this scenario, the network device needs to configure corresponding first resources for multiple terminal devices in multiple common PURs. This method of determining the first resource may also be referred to as a contention free approach or a noncompetitive approach. For example, the first terminal device may directly select the first resource from the multiple common PURs. In this scenario, multiple terminal devices may all select the first resource, and the network device needs to determine whether the selection of the first resource by the first terminal device is successful the first resource and provide feedback. This method of determining the first resource may also be referred to as a contention-based approach or a competitive approach.

In some embodiments, multiple common PURs can be configured as content free shared (CFS) preconfigured UL resources (CFS PUR) and/or content based shared (CBS) preconfigured UL resources (CBS PUR) based on how the terminal device selects the uplink resources from multiple common PURs.

As an example, multiple common PURs may include multiple CFS PURs, or multiple common PURs may be multiple CFS PURs. Since CFS PUR is contention free, multiple terminal devices, including the first terminal device, determine the uplink resources based on the contention free approach.

As an example, multiple common PURs may include multiple CBS PURs, or multiple common PURs may be multiple CBS PURs. Since CBS PUR is contention based, multiple terminal devices, including the first terminal device, select resources using a contention resolution scheme to determine the uplink resources.

As an example, multiple common PURs may include multiple CFS PURs and multiple CBS PURs. For example, multiple terminal devices may be divided into two groups based on resource selection approaches, each determining uplink resources through distinct approaches. For example, multiple terminal devices may prioritize selecting resources from CFS PURs based on the contention free approach. When remaining resources in CFS PURs are insufficient, multiple terminal devices select resources from CBS PURs based on the contention based approach. For example, multiple terminal devices may prioritize selecting resources from CBS PURs based on the contention based approach. When remaining resources in CBS PURs are insufficient, multiple terminal devices select resources from CFS PURs based on the contention free approach.

In some embodiments, the first resource may be one from either contention free PURs or contention based PURs. Regardless of the approach used by the first terminal device to determine the uplink resource, the uplink resource is collectively referred to as the first resource for transmitting the first message.

In some embodiments, if contention based PURs are supported, the network device needs to configure one or more CBS PURs. If contention free PURs are supported, the network device needs to configure one or more CFS PURs. For example, in an NTN cell, multiple contention based common PURs may be introduced for different coverage tiers, coverage areas, and/or carriers within the cell.

In some embodiments, when the first resource is a contention free PUR, the first terminal device needs to send a resource request to determine the first resource corresponding to it; and when the first resource is to a contention based PUR, the network device needs to determine whether the terminal device contending for the first resource is the first terminal device and provide feedback. For ease of understanding, specific explanations are provided below in conjunction with multiple embodiments.

### Embodiment 1

In this embodiment, the first terminal device selects the first resource from multiple common PURs using a contention resolution scheme. That is, the first resource is one of the contention based common PURs (CBS PURs). The first resource is used to transmit an EDT (Early Data Transmission) or an EDT request. With this approach, the network device has no prior knowledge of which terminal device will select which resource from the multiple common PURs to transmit the EDT request.

To address this issue, an embodiment of the present application proposes a method for wireless communication. When the first terminal device transmits the first message on the first resource, the network device can determine which terminal device the first EDT requested by the first message originates from, based on a first RNTI. Herein, the first RNTI may be associated with the first resource or carried within the first message. Based on this method, the network device can determine the source terminal device of each received EDT request and provide feedback, thereby mitigating collisions among different terminal devices.

To facilitate understanding, a method for wireless communication proposed in the embodiments of the present application is described in detail below with reference to FIG. 3. FIG. 3 illustrates from a perspective of interaction between the first terminal device and the network device. The first terminal device can be any type of communication terminals described earlier, such as a UE. The network device can be any type of access network device or core network device described earlier, such as a gNB or eNB.

In some embodiments, the first terminal device may be a terminal device performing uplink transmission to the network device or receiving downlink transmission from the network device, with no specific constraints imposed herein.

In some embodiments, the first terminal device may be a terminal in a network experiencing prolonged propagation delays. Optionally, the first terminal device may be a terminal device in an NTN system. That is, the serving cell of the first terminal device is an NTN cell. Alternatively, the first terminal device is a terrestrial terminal within an NTN cell. As an example, the first terminal device may be a terminal in an NB-IoT system.

As an example, the first terminal device is located within the coverage area of a satellite. For instance, the first terminal device is an NTN IoT terminal.

In some embodiments, the first terminal device may be a terminal device performing sidelink transmission to other terminal devices.

In some embodiments, the network device can be any type of network side device of a communication system. The communication system may be, for example, NTN system.

As an example, the network device may include a satellite in an NTN system, with the first terminal device being a terminal device within a cell served by the satellite. For example, when a base station is deployed on the satellite, the first terminal device may communicate directly with the satellite-based base station. For example, when the satellite acts as a relay, the first terminal device may communicate with a ground-based network device via the satellite.

As an example, when the network device includes a satellite, the first terminal device may be located within the service area of the satellite at the current moment to transmit or receive data via the satellite.

In some embodiments, the first terminal device is a terminal currently in an idle state (also known as idle mode). That is, at the current moment, the first terminal device is not in an RRC connected state with the network device.

In some embodiments, the first terminal device may be one of multiple terminal devices within its serving cell. The multiple terminal devices can each perform the method provided by the embodiments of the present application. For example, the multiple terminal devices may each transmit the first message requesting EDT.

Referring to FIG. 3, in step S310, the first terminal device transmits the first message on the first resource. Correspondingly, the network device receives the first message on the first resource.

The first message may include different types of messages or one or more types of information, with no specific constraints imposed herein.

In some embodiments, the first message may be an uplink message in a random access procedure. For example, the first message is Msg3 in a RACH-less access procedure. In a RACH-less access procedure, the first terminal device skips the transmission of Msg1 and the reception of Msg2 in the random access procedure and directly transmits Msg3. Because the transmission of Msg3 skips Msg1 and the RAR, the first terminal device does not receive the RNTI information from the RAR before receiving Msg4, and therefore cannot determine the transmission resource for Msg3 via the RAR.

As an example, the first message is a non-RACH message transmitted directly by the first terminal device to the network device while in the idle state. Therefore, the first message may be the PUSCH transmission message transmitted by the first terminal device for the first time.

The first message is used for requesting the first EDT and therefore may include a corresponding request. In some embodiments, the first terminal device may transmit an Early Data Request via the first message to the network device to perform uplink data transmission without establishing an RRC connection.

As an example, the first message may be used for the first terminal device to perform an upper-layer establishment request, or resume an RRC connection. For example, the first message may include an RRCConnectionResumeRequest.

As an example, the first message may be used for the first terminal device to establish a connection or resume request for an originating call.

As an example, the first message may include an Early Data Request, such as RRCEarlyDataRequest.

As an example, the first message may include data requiring early transmission. For instance, the first terminal device may transmit the UL data together with the RRCEarlyDataRequest or RRCConnectionResumeRequest in the first message.

As mentioned earlier, the network device may configure multiple shared common PURs for multiple terminal devices. To facilitate identification of the first messages separately transmitted by the multiple terminal devices via the multiple common PURs, each common PUR may correspond to a distinct RNTI. It should be noted that the embodiments of the present application define a new RNTI type for the multiple common PURs to uniquely identify the transmission of the first message.

In some embodiments, multiple RNTIs are used for identifying EDT requests transmitted by multiple terminal devices or for identifying multiple common PURs. Therefore, the multiple RNTIs may be multiple EDT-RNTIs or multiple PUR-RNTIs.

The multiple RNTIs include a first RNTI which enables the network device to determine the first terminal device corresponding to the first EDT. In other words, when the network device receives the first EDT or the first EDT request, it can identify that the first EDT originates from the first terminal device based on the first RNTI. This facilitates feedback (via a feedback message for the first EDT) and enables contention-based resource allocation.

As an example, the first RNTI is a first EDT-RNTI or a first PUR-RNTI.

The first RNTI may be an RNTI corresponding to the first resource or an RNTI included in the first message. That is, the first RNTI corresponds to the first resource, or the first message includes the first RNTI. When the first RNTI corresponds to the first resource, the network device can determine that the terminal device requesting the first EDT is the first terminal device based on the first resource. When the first message includes the first RNTI, the network device can determine that the terminal device selecting the first resource or requesting the first EDT is the first terminal device based on the first message.

As an example, the first RNTI may be used to identify the first resource, that is, the time-frequency resource used to transmit the first message.

In some embodiments, the first terminal device may determine the first RNTI through multiple approaches. Optionally, the first terminal device may obtain the RNTI for Msg4 related to CBS PUR through two approaches: via network (NW) configuration, or via computation by the first terminal device itself. The network device utilizes this RNTI to provide feedback regarding the request or transmission of the first EDT in the first message.

As an example, the first terminal device may determine the first RNTI based on configuration of the network device. For example, network-side equipment may assign the RNTI through an RRCConnectionRelease message. That is, the NW can assign an EDT-RNTI dedicated to the first terminal device. The first terminal device may acknowledge the correspondence with the first RNTI based on the connection release message while in the connected state.

As an example, when the first terminal device determines the first RNTI via network configuration, it may select the first resource based on the first RNTI. When the first RNTI is a first EDT-RNTI, the multiple EDT-RNTIs including this first EDT-RNTI are associated with indices of the multiple common PURs. That is, the network device configures which common PUR is for which EDT-RNTI.

As an example, the first terminal device may calculate the first RNTI based on the configuration of the multiple common PURs. For example, the network device can configure the multiple common PURs via SIB. The first terminal device can compute the first RNTI based on this configuration by itself and monitor the physical downlink control channel (PDCCH) carrying the feedback message.

As an example, the first terminal device determines the first RNTI based on the configuration of the multiple common PURs and the first resource. For example, the first RNTI is computed based on the time-frequency resource (first resource) of the PUSCH used for the first message. For example, after the base station has configured the PUR shared resource pool, each allocated resource block has a corresponding EDT-RNTI. When the first terminal device transmits the first message using the first resource, it computes the first EDT-RNTI based on the first resource and stores the first EDT-RNTI for subsequent monitoring.

In some embodiments, the network device may also determine the first RNTI through various approaches. Optionally, after receiving the first message on the first resource, the network device can determine the first RNTI based on the first resource or the first message.

As an example, when the network device configures the first RNTI for the first terminal device, the first RNTI may be carried in the first message. After receiving the first message, the network device determines that the first EDT originates from the first terminal device. For example, after receiving the first RNTI configured by the network device, the first terminal device may select the first resource for transmitting the first message based on the configured first RNTI.

As an example, after receiving the first message on the first resource, the network device may determine the first RNTI based on the first resource. For example, after receiving the Msg3, the base station also computes the EDT-RNTI to derive the first RNTI. The base station may use the first RNTI to scramble the cyclic redundancy check (CRC) of the downlink control information (DCI) format 1_0 in the PDCCH for Msg4 (which includes the feedback for the first EDT). Only the terminal device that transmits the first message on the time-frequency resource (first resource) identified by the first RNTI can correctly decode the DCI in this PDCCH.

In some embodiments, multiple common PURs may be utilized by multiple terminal devices. The first RNTI may be determined based on the position of the first resource in the multiple common PURs, and/or the terminal device group to which the first terminal device belongs.

As an example, when the first terminal device is terminal device j in terminal device group i, the first RNTI is given by:

$$EDT - RNTI ( i , j ) = 1 + {s}_{i d} ( i , j ) + 14 \times {t}_{i d} ( i , j ) + 14 \times M ( i ) \times {f}_{i d} ( i , j ) + 14 \times M ( i ) \times N ( i ) \times {ul}_{carrier , id} ;$$

where s_{id}(i,j) represents the index of the symbol corresponding to terminal device j in the multiple common PURs, t_{id}(i,j) represents the index of the slot corresponding to terminal device j in the multiple common PURS, f_{id}(i,j) represents the index of the frequency domain resource corresponding to terminal device j in the multiple common PURs, M(i) represents the total number of slots configured for terminal device group i, N(i) represents the total number of frequency domain resources configured for terminal device group i, and ul_{carrier,id} represents the index of the uplink carrier corresponding to the first message.

Optionally, the symbol referenced in the above formula denotes an orthogonal frequency division multiplex (OFDM) symbol.

Optionally, s_{id}(i,j) is selected from the set of s_id values, where 0≤s_{id}<14.

Optionally, M may represent the maximum number of slots configured across multiple terminal device groups, and t_{id}(i,j) is selected from the set of t_{id} values, where 0≤t_{id}<M.

Optionally, N denotes the maximum number of frequency domain resources, and f_{id}(i,j) is selected from the set of f_{id} values, where 0≤f_{id}<N.

Optionally, for normal uplink (NUL) carriers, ul_{carrier,id}=0; while for supplementary uplink (SUL) carriers, ul_{carrier,id}=1.

In some embodiments, the first terminal device is one of multiple devices requesting EDT within an NTN cell. Given the extremely large number of devices in an NTN cell, terminal devices requesting EDT or all terminal devices within the cell may be divided into multiple terminal device groups. The multiple RNTIs including the first RNTI may be associated with the multiple terminal device groups. That is, dividing multiple terminal devices into multiple terminal device groups facilitates more efficient RNTI determination by both terminal devices and the network device.

In some embodiments, the terminal device groups may be defined based on one or more of the following information: service type of the terminal devices; service time of the terminal devices; geographic location of the terminal devices and/or sub-regions of the NTN cell.

As an example, the first RNTI configured by the network device correlates with the terminal device group to which the first terminal device belongs. The assignment of the first terminal device to a specific terminal device group is determined based on one or more of the following information: service type of the first terminal device; service time of the first terminal device; geographic location of the first terminal device and/or sub-regions of the NTN cell.

To facilitate understanding, we illustrate below using multiple EDT-RNTIs across different implementation approaches.

As an implementation approach, the terminal device group to which the first terminal device belongs may be determined based on the service type of the first terminal device. In this scenario, the network device divides terminal devices into terminal device groups according to their service types. Correspondingly, the network side can configure service-specific EDT-RNTIs for each terminal device group. For example, the network side can divide all EDT-RNTIs into multiple groups, with each group corresponding to one service type. When services of one type use one group of EDT-RNTIs, these service-specific EDT-RNTI allocation can reduce blind decoding resource consumption at the network device when processing multiple first messages. Illustration with Msg3 processing, while the network device cannot immediately identify which specific terminal device transmitted the received Msg3, the network device is aware of the service type of the terminal device. In this approach, the network device only needs to perform blind decoding on received Msg3 using the EDT-RNTI group corresponding to the service type, instead of trying all possible EDT-RNTIs.

As another implementation approach, the terminal device group to which the first terminal device belongs may be determined based on the service time of the first terminal device. The service time of the first terminal device represents either remaining time of current service of the first terminal device or remaining service time of the current satellite. The network device may set multiple service time thresholds to divide the multiple terminal devices into multiple terminal device groups. The network device allocates EDT-RNTI groups based on the service time of each terminal device group. When the terminal device group to which the first terminal device belongs corresponds to shorter service time, the first terminal device can use front-loaded time-frequency resources.

As another implementation approach, the terminal device group to which the first terminal device belongs can be determined based on the first terminal device's geographic location and/or sub-regions of the NTN cell. The NTN cell can be divided into multiple sub-regions (also known as sub-cells). Within the NTN cell, distance to cell edge varies across different sub-regions. For example, multiple terminal devices in adjacent locations may form one terminal device group. For example, multiple terminal devices within the same sub-region may form one terminal device group. That is, the sub-regions correspond to the terminal device groups, and the number of sub-regions equals the number of terminal device groups. Each sub-region has a region ID. One region ID corresponds to one terminal device group. Each terminal device group is allocated an EDT-RNTI group.

In the above implementation approach, the NTN cell is divided into annular sub-regions. The network device can group the multiple terminal devices based on region IDs of sub-regions and geographic locations of terminal devices.

In the above implementation approach, multiple common PURs are allocated for terminal devices across different sub-regions. Consequently, multiple sub-regions respectively correspond to multiple common PUR groups. The size of each common PUR group is determined based on the number of the multiple sub-regions, and/or the distance from each sub-region of the multiple sub-regions to the NTN cell edge. Given NTN's extensive coverage, it can achieve resource multiplexing by multiple terminal devices sharing PURs based on multiple sub-regions. Multiple common PURs may be divided into multiple sub-region-specific common PUR groups. The common PURs corresponding to a specific sub-region are only available to the terminal devices in this specific sub-region.

As an example, when there are a large number of sub-regions, the size of each common PUR group in multiple common PUR groups is relatively small.

As an example, when the distance between a specific sub-region and the edge of the NTN cell is small, the corresponding common PUR group to this specific sub-region is relatively small.

As an example, multiple common PUR groups can be represented as M(i) as described earlier. The size of M(i) correlates with the corresponding sub-region's ID. The multiple common PURs can be evenly divided by the number of region IDs, with each region dividing M_{average} time slots. The size of M(i) for each group can be M(i)=(1/Q)×M_{average}; where Q represents a scaling factor and is a rational number. The value of Q being 1 indicates equal distribution of resources.

As an example, the common PUR group corresponding to each sub-region can be disseminated via multicast to all terminal devices within the NTN sub-region. For example, the NTN can send information about sub-region IDs to all terminal devices through broadcast messages, and each terminal device can determine its belonging sub-region using GNSS positioning information. As an example, the value of the region ID may be {1, 2, 3, 4 . . . }. Higher region ID value indicate closer proximity to NTN satellite coverage edge and smaller value of M(i).

In some embodiments, the network device may directly group EDT-RNTIs, or group EDT-RNTIs based on specific grouping of terminal devices. Optionally, when the network device directly groups RNTIs, multiple RNTIs are divided into multiple RNTI groups. Optionally, the multiple RNTI groups correspond to multiple terminal device groups.

As an example, when the first RNTI belongs to a first RNTI group in the multiple RNTI groups, the first message includes an identifier of the first RNTI group. This identifier can facilitate blind decoding by the network device via RNTIs in the first RNTI group.

As an example, the network device first allocates an EDT-RNTI group (e.g. based on the same service type) to a terminal device group, and the EDT-RNTIs of the terminal devices within this terminal device group can be determined based on this EDT-RNTI group. For example, EDT-RNTIs are divided into G groups, where G is a positive integer. Each group has a group identifier, and EDT-RNTI (i) based on the group identifier has X group members, where i is a positive integer ranging from 1 to G. The identification of X group members may be EDT-RNTI (i)₁, EDT-RNTI (i)₂, EDT-RNTI (i)₃, . . . , EDT-RNTI (i)_{X}.

In the above embodiments, multiple terminal devices may request access at the same time. If the first terminal device fails to transmit the first message using EDT-RNTI(i)1, it sequentially falls back to EDT-RNTI(i)₂ for retransmission, and so on. If the first terminal device successfully transmits the first message using EDT-RNTI(i)₂, the base station blindly decodes the message using all indices within EDT-RNTI(i). As the decoding is restricted to a specific group, the base station can successfully decode the first message in a short time.

In some embodiments, the first RNTI is determined based on one or more of the following parameters: ID of the first terminal device, cell RNTI (C-RNTI), and temporary mobile subscription identifier (TMSI). Both the network device and the first terminal device can compute the first RNTI using these parameters. It should be understood that the first RNTI can also be determined based on other parameters.

As an example, the first RNTI is determined based on the ID of the first terminal device or TMSI. For example, the first terminal device computes the first RNTI based on its own ID and carries the first RNTI in the first message.

As an example, the first RNTI is determined based on the C-RNTI. For example, the first terminal device retains the C-RNTI for a period of time Tmax after transitioning from RRC connected state to RRC idle state. That is, if the first terminal device is idle for more than Tmax, the C-RNTI will not be stored. If the idle time is less than or equal to Tmax, the first message carries C-RNTI MAC CE. If the idle time is greater than Tmax, the first message does not carry C-RNTI MAC CE. For example, the first terminal device sets the timer Tmax. After receiving the RRC release message, the first terminal device initiates the timer Tmax and retains the C-RNTI. The first message carries C-RNTI, and the downlink feedback sent by the network device uses C-RNTI to calculate the first RNTI, and indicates the result of contention resolution through the PDCCH scrambled by the first RNTI.

For example, when Tmax expires, the first terminal device discards the stored C-RNTI. When transitioning from RRC idle state to RRC connected state, the first terminal device uses the first RNTI to transmit the first message. The first RNTI cannot be calculated through C-RNTI. The downlink feedback sent by the network device uses the first RNTI to indicate the result of contention resolution.

Referring further to FIG. 3, in step S320, the first terminal device receives the feedback message of the first EDT sent by the network device.

The feedback message of the first EDT is used to indicate whether the first EDT or the first EDT request is successful. In some embodiments, when the first terminal device requests the first EDT, it needs to wait for the feedback message. In some embodiments, the first terminal device also needs to wait for the feedback message after directly transmitting the to-be-transmitted data, corresponding to the first EDT, in the first message. For example, after the first terminal device transmits UL data together with Early Data Request or RRCConnectionResumeRequest, it cannot be considered that EDT has been successfully completed. Only when the RRC message indicates that the network device has successfully received UL data, can the first EDT be considered successful.

As an example, the feedback message of the first EDT is used to indicate the result of contention resolution.

As an example, the feedback message of the first EDT is carried in the PDCCH (DCI), and the first terminal device monitors the message.

In some embodiments, the feedback message of the first EDT may be any one or more type of information received by the first terminal device. For example, the feedback message of the first EDT is one or more of the following: RRCEarlyDataComplete; RRCCnnectionRelease; ContentionResolution; and acknowledgement (ACK) from layer 1 (L1) and/or layer 2 (L2).

In some embodiments, the feedback message of the first EDT is determined based on the type of the first message. For example, when the first message requesting the first EDT is an RRCEarlyDataRequest, the feedback message is RRCEarlyDataComplete. For example, when the first message is RRCConnectResumeRequest, the feedback message is RRCConnectionRelease.

As an example, the first terminal device considers the first EDT or the first EDT request successful only when it receives the RRCEarlyDataComplete or RRCCconnectionRelease message.

As an example, ContentionResolution includes Mg4 ContentionResolution. When the first message is Msg3, the feedback message of the first message can be Mg4 ContentionResolution. If the first RNTI carried by Mg4 ContentionResolution is consistent with the one reported by the first terminal device in Msg3, the first terminal device confirms successful EDT data transmission.

In some embodiments, after the first EDT is successful, the network device may also terminate the EDT procedure via an ACK without data. The ACK can be L1/ACK or L2/ACK. For example, in the PUR shared resource pool, the network devices can terminate the EDT procedure by sending a TA command (TAC) containing no data or RRC response message L1/ACK, L2/ACK.

In some embodiments, the first terminal device receives the feedback message of the first message based on a first timer. The first timer is also called a contention resolution timer. For example, the first terminal device initiates the first timer after transmitting the first message; and terminates the first timer after receiving the feedback message of the first message.

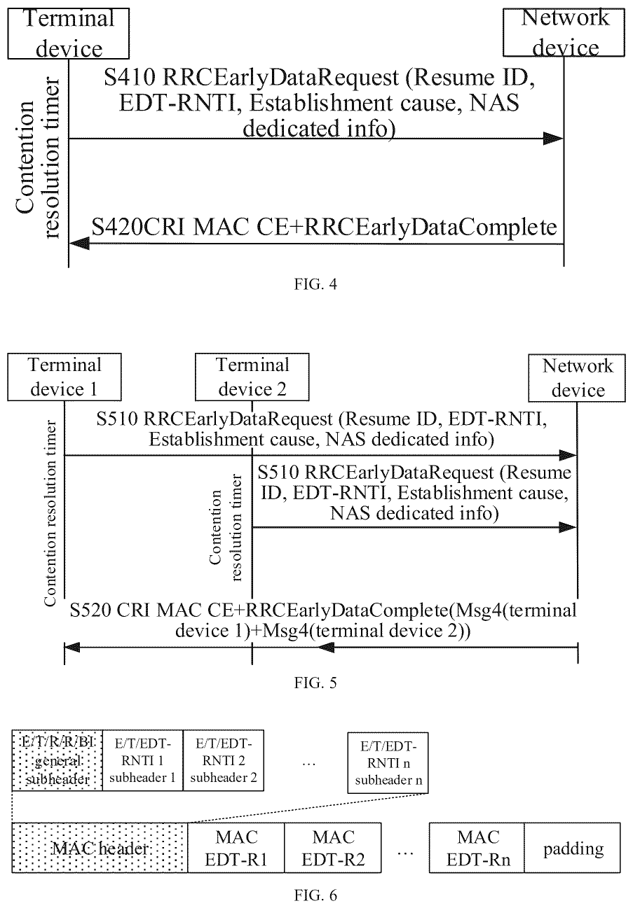

For ease of understanding, an exemplary introduction is provided below in conjunction with FIG. 4. FIG. 4 illustrates from a perspective of interaction between a terminal device and a network device. The terminal device in FIG. 4 may be the first terminal device, and the first RNTI is EDT-RNTI. The terms already explained in the previous text will not be repeated.

Referring to FIG. 4, in step S410, the terminal device transmits RRCEarlyDataRequest to the network device. This request may be the first message. Compared to step S210 in FIG. 2, the request here includes not only the resume ID, establishment cause, and NAS dedicated information, but also the EDT-RNTI corresponding to the terminal device. Step S420 is identical to step S220 in FIG. 2 and will not be repeated here. As shown in FIG. 4, after executing step S410, the terminal device initiates the contention resolution timer. When executing step S420, the timer stops counting.

As shown in FIG. 4, the contention resolution timer enables the terminal device to monitor the feedback message sent by the network device and timely rollback. During Mac contentResolution Timer, if the EDT-RNTI carried in the Mg4 ContentionResolution message received by the terminal device is consistent with the one reported in Early Data Request, then the terminal device considers that the EDT data has been successfully transmitted. Otherwise, the terminal device considers its request failed and reattempts access according to the rules described earlier.

In some embodiments, if the first EDT is unsuccessful, the first terminal device determines whether to perform a random access procedure. For example, if the first terminal device does not receive a success indication of the first EDT or first EDT request, the first terminal device re-transmits the first message to request or perform the first EDT. For example, if the first terminal device does not receive a success indication of the first EDT or first EDT request within the set time of the first timer, the first terminal device returns to the normal random access procedure and performs normal data transmission. That is, the first terminal device abandons the current Early Data Request or EDT.

In some embodiments, the first resource may be used for some or all of the terminal devices in the first terminal device group to request EDT. As mentioned earlier, the first RNTI may be associated with the transmission resource (first resource) used for the first message. Taking Msg3 as an example, if multiple terminal devices transmit Msg3 on the same resource, the responses (feedback messages) to multiple terminal devices can be multiplexed in a single Msg4. That is, the network device can send a “multiplexed Msg4” to multiple terminal devices instead of sending individual Msg4 separately.

As an example, the network devices can perform multiplexed transmission of feedback to multiple terminal devices via a single physical downlink shared channel (PDSCH).

For ease of understanding, the following provides an exemplary illustration of the multiplexing process of feedback to multiple terminal devices in conjunction with FIG. 5. FIG. 5 illustrates the interaction between two terminal devices and the network device. The two terminal devices are terminal device 1 and terminal device 2, respectively.

Referring to FIG. 5, in step S510, terminal device 1 and terminal device 2 respectively transmit RRCEarlyDataRequests and initiate the contention resolution timers. The content of the request herein is identical to that in the step S420 of FIG. 4, and will not be repeated here.

In step S520, the network device provides information feedback to both terminal device 1 and terminal device 2 at the same time via one single feedback message. As shown in FIG. 5, the feedback message sent by the network device includes Msg4 for terminal device 1 and Msg4 for terminal device 2.

As an example, the network device schedules multiple Msg4 in one single MAC PDU. Multicast Msg4 or multiple Msg4 scheduled in one single DCI (Msg4 multiplexing for multiple terminal devices) can be used as a solution.

In some embodiments, due to the fact that the number of terminal devices in the NTN system can reach tens of thousands, when multiple terminal devices synchronously send transmit the first message based on regional grouping/service type, the feedback messages of the multiple first messages can be a group message. That is, multiple feedback messages corresponding to multiple terminal devices can be sent via a group signaling message.

As an example, a group message can be used to send feedback messages to all terminal devices requesting EDT in one terminal device group. This terminal device group can be referred to as a first terminal device group. For example, the feedback message of the first EDT is embedded within the group message. The group message includes feedback messages to some or all of the terminal devices in the first terminal device group requesting EDT, the some or all of the terminal devices including the first terminal device.

As an example, group information (group message) is established for all terminal devices initiating Msg3 and having EDT-RNTI. The group message includes feedback messages to all terminal devices transmitting EDT-RNTI Msg3. The group message is broadcasted to all terminal devices within the group.

As an example, in an NTN cell, the movement speed of terminal devices can be considered almost stationary relative to the movement speed of satellites, especially for IoT terminals. Therefore, the network device can establish a group for each sub-region. The group can be established based on temporary mobile group identifier (TMGI), session ID, group RNTI (G-RNTI) and semi persistent scheduling G-RNTI (SPS G-RNTI), configuration information of service data adaptation protocol (SDAP) entities, configuration information of packet data convergence protocol (PDCP) entities, configuration information of radio link control (RLC) entities, and physical layer configuration information.

As an example, in order to receive the group message, the terminal device can perform the same network access procedure as unicast and enter the same state as after unicast network access. At the physical layer, multicast (packet transfer mode, PTM) reception has only one step: the terminal device obtaining configuration information for blind detection of multicast broadcast service traffic channels (MTCHs) via RRC signaling. Based on the configuration information, PDCCH blind detection obtains scheduling information for MTCHs. Multicast data is obtained from the multicast transmission channels (MTCHs/PDSCH) carried on the PDSCH based on MTCHs scheduling information.

As an example, in order to receive the multiplexed group message, the terminal device can perform the normal network access procedure. When in RRC connected state, the terminal device can obtain configuration information of its group via blind detection of RRC signaling. The configuration information of the group, such as group ID, TMSI, etc., is stored in the terminal device and base station and is not released over time unless the configuration information of the group is obtained again based on re-random access. According to the group configuration information, PDCCH is monitored to obtain the group scheduling information. According to the group scheduling information, terminal devices with a specific region ID/group ID can receive the group message containing multiple feedback messages.

In some embodiments, the structural design of the group message needs to consider the correspondence between multiple terminal devices and multiple feedback messages. As an example, the group message can be carried within a MAC service data unit (SDU).

For example, when the first terminal device belongs to the first terminal device group, the group message including the first EDT feedback message can be carried in first MAC SDU. Reserved bits in the header of the first MAC SDU can be used to indicate the service type corresponding to the first terminal device group or the ID of the sub-region where the first terminal device group is located.

For ease of understanding, the following provides an example of a possible structure of MAC SDU to illustrate the group signaling message with reference to FIG. 6. The MAC SDU in FIG. 6 may be the first MAC SDU, and MAC EDT-Rn represents the response to terminal device n. As shown in FIG. 6, the MAC SDU includes a MAC header, responses for n terminal devices, and padding.

Referring to FIG. 6, the MAC header includes a general subheader and n device subheaders corresponding to n terminal devices. The n device subheaders are device subheader 1, device subheader 2, . . . , and device subheader n. The general subheader includes fields of E/T/R/R/BI, while other device subheaders include fields of E/T/EDT-RNTI n. R represents reserved bit. The meanings of each field in FIG. 6 are listed as follows.

E: extension field, which is a flag indicating whether the MAC subPDU containing this MAC subheaderer is the last MAC subPDU in the MAC PDU. If E field is 1, there is at least one MAC subPDU following it; and if E field is 0, it indicates that this subPDU is the last MAC subPDU in the MAC PDU.

T: Type field, which is a flag indicating whether the MAC subheader contains an EDT ID or a backoff indicator (BI). If T field is 0, it indicates that there is no BI in the subheader and no overload; if T field is 1 and presents in the general subheader, it indicates that not all terminal devices are satisfied; and if T field is 1 and presents in a subsequent device subheader, it indicates that the corresponding terminal device does not have EDT-RNTI.

R: reserved field, which is a reserved resource and can be set as NTN region ID field or business type ID.

BI: backoff field, which indicates the overload situation in the cell, with a size of 4 bits representing 16 possible indices.

EDT-RNTI: EDT field, which is used to identify the EDT-RNTI corresponding to each terminal device. The size of the EDT-RNTI field is 16 bits.

In some embodiments, the first message may be transmitted based on the first TA value. That is, the first terminal device performs uplink transmission of the first message based on the first TA value. As an example, the first TA value has not been adjusted by any NW. The first TA value should be a valid timing alignment value for uplink transmission.

As an example, in order to support direct transmission of Msg3 in the deployment of low earth orbit (LEO) satellites, the first terminal device needs to estimate whether the TA value is accurate enough for first Msg3 transmission or first PUSCH transmission.

In some embodiments, the first TA value can pre-compensate for the current TA to improve accuracy. For example, the first terminal device may perform transmission of the first message based on pre-compensated TA. Therefore, the first TA value may also be referred to as the compensation value of TA.

As an example, the current TA may be the TA value of the first terminal device before pre-compensation. For example, the current TA may be determined by the first terminal device based on the currently stored TA. When multiple TA values are stored, the first terminal device may select the most recent stored TA as the current TA, or select the maximum, minimum, or average of the stored TAs as the current TA.

In some embodiments, the first TA value may be pre-compensated based on one or more of the following parameters: duration of the first terminal device in idle state; last stored TA value by the first terminal device during previous TA adjustment; maximum TA pre-compensation value when the first terminal device was in previous connected state; and path loss and Doppler frequency shift when the first terminal device receives configuration information of multiple common PURs. The parameters determined by the above parameters for pre-compensating the first TA value can also be referred to as the compensation value of the first TA value.

As an example, the first TA value is determined based on the duration of being idle. The first terminal device can determine the duration of itself being in RRC idle state, that is, the duration of idle state. For example, the duration of idle state can be used to determine a calculation factor for the current TA. The first terminal device can determine the first TA value based on the current TA and the calculation factor.

As an example, the first TA value is determined based on the last stored TA value from previous TA adjustment. The last stored TA value from the previous TA adjustment refers to the TA value stored by the first terminal device during the most recent TA adjustment (e.g. in RRC connected state). For example, the first terminal device can configure corresponding compensation parameters to compensate for the TA value and determine the first TA value.

As an example, the first TA value is determined based on the duration of being idle and the last stored TA value during previous TA adjustment. For example, if the duration of the first terminal device being in the idle state is T_{delay}, and the TA value stored during the previous TA adjustment is TA, the first TA value or its compensation value is T_{delay}×TA. In the NTN system, when T_{delay}×TA is directly used as the first TA value, it may be smaller than the maximum TA value estimated based on the maximum Doppler frequency shift within the NTN cell.

As an example, the first TA value is determined based on the maximum TA pre-compensation value when the first terminal device was in previous connected state. That is, the first terminal device can perform initial compensation based on the maximum TA pre-compensation value in the previous connection when performing TA pre-compensation.

As an example, the first TA value is determined based on path loss and Doppler frequency shift when the first terminal device receives configuration information of multiple common PURs. The configuration information of multiple common PURs is, for example, configuration parameters related to common PURs issued by the network device. For example, the first terminal device may trigger a PUR request. When the network issues PUR configuration to the first terminal device, the first terminal device can estimate the path loss and Doppler frequency shift based on the signaling issued by the network, to further adjust the TA value.

The method for determining the first resource based on contention solution was introduced in the previous text in conjunction with FIGS. 3 to 6. The above method allows the network device not to configure PUR for each terminal device, and can be applied to EDT scenarios with massive terminal devices in cells such as NTN.

### Embodiment 2

In this embodiment, the first terminal device selects the first resource from multiple common PURs in a contention free approach. That is, the first resource is one of the contention free common PURs (CFS PURs). As mentioned earlier, when the first resource is determined based on contention, multiple terminal devices may select the same resource to transmit EDT or EDT requests. In such scenario, some PURs in the multiple common PURs may be overloaded with excessive messages, while others may be idle.

To address this issue, embodiments of the present application further propose another method for wireless communication. In this method, the network device configures the first resource for the first terminal device to transmit EDT or EDT request. Through this method, multiple terminal devices can transmit EDT requests separately on the configured resources, and the network device can know which terminal device the received EDT request comes from, thereby avoiding resource waste.

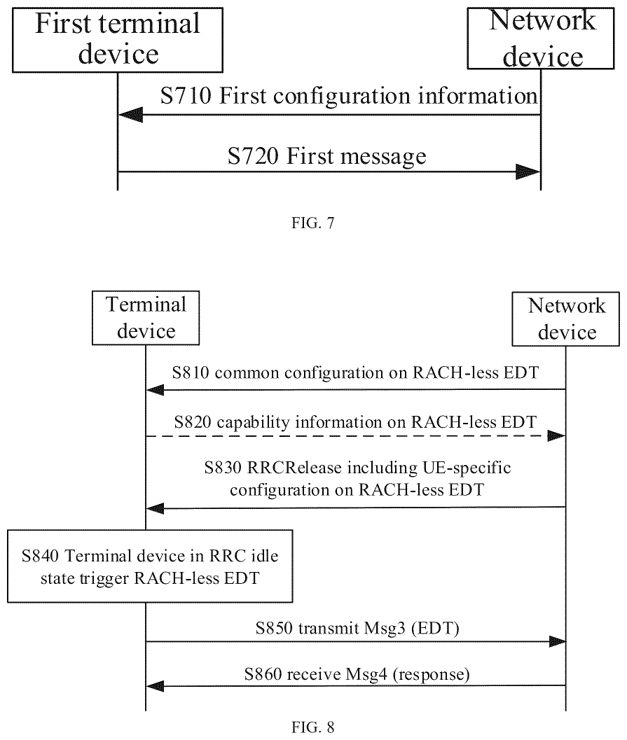

To facilitate understanding, the method for wireless communication is described in detail below with reference to FIG. 7. FIG. 7 illustrates the method also from a perspective of interaction between the first terminal device and the network device. For the sake of simplicity, the terms already explained in FIG. 3 will not be repeated.

Referring to FIG. 7, in step S710, the first terminal device receives the first configuration information sent by the network device.

The first configuration information may be carried in SIB or RRC dedicated signaling. That is, the network device can provide corresponding configuration information to each terminal device based on dedicated RRC signaling or broadcast signaling.

As an example, RRC dedicated signaling may include the RRCConnectionRelease message. For example, the first configuration information may be carried in the RRCConnectionRelease message sent by network devices before the first terminal device enters idle mode, in order for the first terminal device to receive it. For example, the configuration of multiple common PURs may be sent to terminal devices through the RRCConnectionRelease message.

The first configuration information is used for the first terminal device to determine the first resource. As mentioned earlier, the first resource is used for transmission of the first message, and the first message is used to request or perform the first EDT. The first resource is one of the multiple common PURs.

As an example, when the network device releases the first terminal device to RRC idle state, the network device configures the first resource to the first terminal device based on multiple common PUR configuration requests, subscription information, and/or local policies.

It should be noted that in FIG. 7, multiple common PURs are used for data transmission in NTN. That is, the present embodiment is used for wireless communication in NTN systems. When the terminal devices in an NTN cell support NTN RACH-less EDT, multiple common PURs can be used.

In some embodiments, the first configuration information may be used to indicate one or more of the following: first RNTI corresponding to the first terminal device; demodulation reference signal (DMRS) resources corresponding to the first terminal device; allocation methods for multiple common PURs; and resource indices in multiple common PURs. As mentioned earlier, the first RNTI may be EDT-RNTI.

As an example, the DMRS corresponding to the first terminal device may be a DMRS dedicated to the first terminal device.

As an example, the network devices may pre-configure dedicated RNTI and/or DMRS resources for each terminal device. In a specific common PUR, multiple terminal devices can simultaneously transmit Msg3. The network device can decode one or more Msg3 from different terminal devices. The network device can distinguish terminal devices via EDT-RNTI (for data scrambling and CRC scrambling) embedded in Msg3 and/or dedicated DMRS. Correspondingly, the network device may use a terminal device-dedicated EDT-RNTI to send Msg4.

As an example, the network device can provide allocation methods for multiple common PURs, enabling terminal devices to determine the corresponding uplink resources.

As an example, the network devices can provide resource indices in multiple common PURs for each terminal device, so that the terminal device can determine the corresponding uplink resources based on the indices in the corresponding configuration information. For example, the network device can configure different resource information for different terminal devices, while other resource information may be the same for all terminal devices. In such scenario, the network device provides multiple groups of common resource information via SIB, and then indicates resource subset indices specific to terminal devices via dedicated signaling.

Referring further to FIG. 7, in step S720, the first terminal device transmits the first message on the first resource. Step S720 is identical to step S610 in FIG. 6. The difference lies in that the first resource in FIG. 7 is configured by the network device for the first terminal device, and is not available to other terminal devices. Therefore, the first terminal device may not wait for the feedback message.

In some embodiments, the first message may include the first RNTI and/or DMRS for identification by the network device. The DMRS may be a DMRS dedicated to the first terminal device.

In some embodiments, the first configuration information may be configured based on a configuration request from the first terminal device. This configuration request may also be referred to as a PUR configuration request. For example, the configuration request transmitted by the first terminal device to the network device can be used to request the first configuration information. That is, after configuring multiple common PURs, the network devices does not allocate corresponding uplink resources to all terminal devices in the cell.

In some embodiments, the configuration request may include one or more of the following types of information: capability information of the first terminal device; service type of the first terminal device; and EDT activation status of the first terminal device.

As an example, the first terminal device may directly transmit a configuration request (explicit request) for uplink resources. For example, the first terminal device directly informs the network device that it is going to transmit the first message and requests the network device to configure the first resource.

As an example, the first terminal device may implicitly request the network device to configure the uplink resources. For example, the first terminal device may activate or deactivate the RACH-less EDT configuration. When the configuration request contains the EDT activation status, the network device may determine whether to configure uplink resources and send the first configuration information based on whether EDT is activated.

For example, the network device may determine whether to send the first configuration information based on whether the first terminal device has activated EDT. When the first terminal device activates the RACH-less EDT configuration, the network device configures the first resource for the first terminal device and sends the first configuration information. When the first terminal device deactivates the RACH-less EDT configuration, the network device does not configure uplink resources for the first terminal device, and therefore does not send the first configuration information.

For example, the first terminal device leverages its capability information to enable/disable EDT configuration functionality. If the capability information of the first terminal device indicates lack of support for EDT activation, the network device does not configure uplink resources for the first terminal device and therefore does not send the first configuration information.

In some embodiments, the configuration request transmitted by the first terminal device may also include a first indication. The first indication is used to indicate whether EDT related transmission enables ACK or negative acknowledgement (NACK) feedback. The first indication is, for example, “RRC ACK”.

As an example, EDT related transmission may include every interaction between terminal devices and the network device during the EDT transmission process.

As an example, EDT related transmission may include all subsequent PUR events after transmitting the first indication.

As an example, in the NTN system, when the first terminal device sends RACH-less EDT under CFS PUR conditions, the first terminal device can send an “RRC ACK” indication in the PUR configuration request. The indication can be applied to all subsequent PUR events configured based on PUR Configuration. For example, ACK/NACK will be sent in each subsequent interaction to indicate whether information has been received.

In some embodiments, the network device may allocate common PUR to each terminal device that transmits a configuration request. For example, when the NTN cell where the first terminal device is located includes multiple terminal devices requesting EDT, multiple common PURs are allocated to multiple terminal devices. For example, the first configuration information can be used to indicate multiple resources corresponding to multiple terminal devices. That is, the first configuration information can indicate multiple uplink resources for multiple terminal devices to conduct the first EDT or request the first EDT. For example, when multiple common PURs are allocated by the base station to each terminal device requesting resources, the allocation may be performed based on the service type of the terminal devices.

In some embodiments, the network device may allocate resources based on the resources requested or demanded by multiple terminal devices.

As an example, the resources requested by multiple terminal devices may be identical, or the network device may allocate resources of uniform size to each terminal device. For example, the resources requested by multiple terminal devices are identical, multiple common PURs can be evenly distributed. In such scenario, the size of the transport block (TB) corresponding to the transmitted data in all EDTs can be set to be the same. If the transport block size in an EDT is insufficient, zero-padding may be performed to achieve a uniform TB size.

As an example, multiple terminal devices may have varying resource demand sizes. For example, the network devices may allocate resources based on the size of resources requested by the multiple terminal devices. For example, the number of assignable resources in multiple common PURs is R (R is a positive integer), and there are K (K≤M) terminal devices that simultaneously request EDT PUR and are admitted to use EDT PUR. The number of resources required for each terminal device in K terminal devices can be represented as Si. The network device may sort Si based on the size of resources simultaneously requested, such as S₀≥S₁≥ . . . ≥S_{K-1}, i=0,1 . . . , K−1. Furthermore, the network device may adjust and allocate resources based on this sorting.

As an example, the resource requested by terminal device i is Sᵢ, and the resource allocated to terminal device i by the network device is Rsi. If Rsi≥Si, the network device allocates resource Si to terminal device i, and the remaining resources become R-Rsi, and so on.

In some embodiments, if the resource allocated by the network device to the first terminal device is greater than or equal to the resource requested by the first terminal device, the first terminal device may directly transmit the first message or perform the first EDT. If the resource allocated by the network device to the first terminal device is less than the resource requested by the first terminal device, the first terminal device cannot transmit the first message or perform the first EDT.

As an example, when the first resource is greater than or equal to the resource requested by the first terminal device, the first EDT is successful; or, when the first resource is less than the resource requested by the first terminal device, the first EDT is unsuccessful.

As an example, multiple common PURs reserved by the network device can be allocated sequentially based on the size of resources requested by terminal devices. If the resource requested by terminal device j is Sⱼ and the available resource Rsj<Sⱼ, then Msg3 access fails. From the perspective of the network device, each terminal device requiring EDT transmission has a relative allocation coefficient to indicate successful allocation or inability to allocate.

In some embodiments, when the first EDT is unsuccessful, the first terminal device may perform the first message retransmission or random access procedure. As an example, the first terminal device may initiate the second timer. When the second timer expires, the first terminal device performs a retransmission of the first message. It can be seen that the second timer is deployed by the first terminal device to schedule retransmission of the first message, and may also be referred to as a contention resolution timer.

As an example, when the first EDT fails, the first terminal device may enter the buffer to wait and initiate the second timer T. The duration of the second timer may be configured by the network device and stored in the first terminal device and/or the network device. During the operation period of the second timer, the first terminal device does not need to retransmit the first message. When the second timer expires, the first terminal device retransmits the first message.

In some embodiments, when the number of retransmissions of the first message reaches a second threshold, the first terminal device performs a random access procedure. That is to say, the first terminal device does not persistently transmit the first message. For example, the first terminal device or the network device may set the number of retransmissions, which is the second threshold. When the number of retransmissions of the first message reaches or exceeds the second threshold, the first terminal device returns to the normal random access procedure and performs normal data transmission.

In some embodiments, it is difficult for a terminal device in RRC idle state to directly restore the use of its specific PUR configuration after reselection to another cell. In such case, after reselecting to a new serving cell, the terminal device has to enter RRC connected state again to request its corresponding PUR configuration.

The above text introduces a method for determining the first resource based on a contention free approach in conjunction with FIG. 7. For ease of understanding, an exemplary introduction is provided below in conjunction with FIG. 8. FIG. 8 illustrates the method also from a perspective of interaction between the terminal device and the network device. The dashed line indicates that the specific process is not mandatory to execute.

Referring to FIG. 8, in step S810, the terminal device receives the common configuration on RACH-less EDT sent by the network device. The network device may be an NTN network. The NTN network sends configuration information of multiple common PURs on RACH-less EDT to the terminal device, or the terminal device may request the network device to send the configuration information of multiple common PURs via a dedicated RRC message PURConfigurationRequest.

In step S820, the terminal device reports the capability information on RACH-less EDT (UE capability on RACH-less EDT). The reported UE capability may also include service type.

In step S830, the network device indicates to the terminal device UE-specific configuration on RACH-less EDT via an RRCRelease message (RRCRelease including UE-specific configuration on RACH-less EDT). The UE-specific configuration refers to the resource configuration information specific to the terminal device.

After step S830 is finished, the RRC state of the terminal device transitions from RRC connected state to RRC idle state. When the terminal device is released to RRC idle state, the UE is specifically configured with PUR. For example, the PUR has been configured in RRCConectionRelease.

In step S840, the terminal device is in RRC idle state and triggers RACH-less EDT (UE in RRC idle initiates RACH-less EDT). The terminal device has transitioned from RRC connected state to RRC idle state.

In step S850, the terminal device transmits Msg3 containing higher-layer data such as RRCEarlyDataRequest/RRCConnectionResumeRequest. The Msg3 may carry UE-specific EDT-RNTI and/or DMRS and be transmitted on the obtained PUR.

In step S860, the network device sends Msg4 for response, and the terminal device receives Msg4. During group-based resource contention procedures, Msg4 may incorporate a contention resolution message and potentially carry higher-layer data.

The preceding description with reference to FIG. 7 and FIG. 8 introduces a method for multiple terminal devices requesting EDT to determine uplink resources in a contention free manner. Through this approach, the potential resource utilization imbalance issue associated with multiple common PURs can be mitigated.

### Embodiment 3

In this embodiment, the first terminal device determines the first resource based on a combination of Embodiment 1 and Embodiment 2. For example, multiple common PURs corresponding to the terminal device group where the first terminal device is located are determined based on a contention free approach. Within the terminal device group, the first terminal device determines the first resource among the multiple common PURs based on contention.

In some embodiments, the first RNTI is specific to the first terminal device. For multiple common PURs corresponding to the terminal device group where the first terminal device is located, the network device needs to perform blind detection on each common PUR to try all possible EDT-RNTIs, and then send Msg4 to notify the first terminal device whether the decoding is successful.

As an example, the first terminal device determines the first resource pool where the first resource is located based on the first configuration information. In the first resource pool, the first terminal device selects the first resource to transmit the first message and monitors the feedback message sent by the network device. That is, the first configuration information is used to indicate the first resource pool, and the first terminal device determines the first resource based on contention in the first resource pool.

In some embodiments, multiple common PURs may be divided into multiple resource pools. The allocation of terminal devices to specific resource pools among multiple resource pools is determined in a contention free manner based on the first configuration information. Specifically, the network device may configure resources within the multiple resource pools using diverse dividing approaches. Within each resource pool, multiple terminal devices determine the corresponding uplink resources based on contention.

As an example, the resource pool where the first resource is located can be determined based on one or more of the following types of information: signal quality of configuration request transmitted by the first terminal device; coverage enhancement (CE) level at the location of the first terminal device; service time of the first terminal device; and service type of the first terminal device. The first terminal device may determine its assigned resource pool based on corresponding parameters.

As an example, multiple common PURs may be divided into multiple resource pools based on one or more of the following types of information: signal quality of configuration requests transmitted by multiple terminal devices; CE levels at the locations of multiple terminal devices; service time of multiple terminal devices; and service types of multiple terminal devices. The signal quality of configuration requests transmitted by multiple terminal devices may also be referred to as energy detection results.

As an example, multiple resource pools are divided according to the CE level. Multiple terminal devices may be configured to determine their respective resource pools based on CE levels. That is, the first terminal device may select the first resource based on its current CE level. The current CE level corresponds to the CE level at the present location of the first terminal device.

For example, for bandwidth reduced low complexity (BL)/CE devices, there exist four PRACH CE levels: 0, 1, 2, and 3. CE levels 0 and 1 correspond to CEModeA; CE levels 2 and 3 correspond to CEModeB.

As an example, multiple resource pools may be divided based on the signal quality of configuration requests. This signal quality is, for example, reference signal received power (RSRP). When the RSRP of a request signal from the first terminal device, as received by the network device, exceeds a first threshold, the first terminal device can use the configured multiple common PURs. That is, if the signal quality of the configuration request transmitted by the first terminal device exceeds the first threshold, the first terminal device determines the first resource within the multiple resource pools.

In the above example, the multiple resource pools are divided based on distinct signal quality ranges. When the signal quality of the configuration request from the first terminal device falls within a first value range, the first terminal device selects the first resource from the resource pool corresponding to the first value range.

As an example, multiple resource pools may be determined based on CE level and signal quality. For the IoT, Msg3 transmissions across different CE levels may correspond to distinct modulation and coding schemes (MCS), repetition counts, and RSRP detection thresholds. For example, the channel quality represented by CE level gradually deteriorates from CE level 0 to CE level 3. CE level 0 represents the scenario with the best channel quality; and CE level 3 represents the scenario with the worst channel quality. Based on the respective RSRP values corresponding to different CE levels, thresholds for the shared resource pool are set separately. That is, the entire resource pool of the common PURs can be divided into four parts according to four CE levels, that is, four resource pools. Each part may correspond to an RSRP threshold: RSRP1, RSRP2, RSRP3, and RSRP4.

As an example, the resource pool where the first resource is located may be determined based on CE Level and carrier configuration. The first terminal device primarily determines its CE level based on the serving cell's RSRP. If Msg3 resource pools corresponding to the selected CE level are configured on multiple carriers, the first terminal device can perform carrier selection. For example, the first terminal device may select a carrier based on a probability factor.

As an example, multiple resource pools may be determined based on the combined results of energy detection and service time. For example, multiple common PURs are first divided into two blocks based on energy detection results. Specifically, a foundational RSRP threshold is established for the resource pool, dividing the resource pool into two resource block subsets: subset A and subset B. When the RSRP of the request signal from the terminal device, as received by the network device, is greater than or equal to the threshold and/or the service time falls beyond T-service, the terminal device can use multiple common PURs and be assigned to a specific resource block subset A. Conversely, when the RSRP of the request signal from the terminal device, as received by the network device, is less than the threshold and/or the service time falls within T-service, the terminal device can use multiple common PURs and be assigned to a specific resource block subset B.

In the above example, the resource subsets A and B used for sharing can be preconfigured, and the starting time slot index of resource subset A is calculated from the starting bit of the entire resource pool. The starting time slot index of resource subset B immediately follows the last time slot index of resource subset A. That is, the temporal position of resource subset A is earlier than that of resource subset B.

In the above example, the starting time slot index of resource subset A can be calculated from a designated bit of the entire resource pool.

As an example, the resource pool where the first resource is located is determined based on the service time of the first terminal device. For example, the first terminal device corresponds to a first NTN cell, and multiple resource pools include a first resource pool and a second resource pool, with the temporal position of the first resource pool being earlier than that of the second resource pool. When the service time of the first terminal device fall beyond the service time (T-service) of the first NTN cell, the first terminal device determines the first resource on the first resource pool so that the first terminal device can timely transmit the first message. When the service time of the first terminal device falls within the service time of the first NTN cell, the first terminal device determines the first resource on the second resource pool. When the service time falls within the T-service, the service of the first terminal device is not urgent, and multiple common PURs may primarily serve other terminal devices whose business service time falls beyond the T-service.

As an example, when the NTN cell where the first terminal device is located supports L types of services, multiple resource pools form L resource pools. The size of each resource pool in L resource pools is determined based on service priority. By way of example, all service types supported within an NTN cell are defined. Assuming L service types are supported according to quality of service class identifier (QCI), when there are M×N physical resource blocks (PRB) per time slot or resource, the allocatable resources per service type are (M×N)/L blocks. That is, under equal distribution, the maximum resources allocated per service type are (M×N)/L blocks. A fairness factor Qⱼ is configured for each service type, where j=0, 1, . . . , L−1. The system may assign fairness factors for each service type based on service priorities. If the maximum resources allocated to each service are (M×N)/L blocks, the resources allocated to service type j are: Qⱼ×(M×N)/L, Qⱼ≤1.

In Embodiment 3, the terminal device may first determine the resource pool for the first resource in a contention free approach, and then select the first resource within the resource pool in a contention based approach to transmit the first message. This method effectively resolves resource conflicts caused by excessive terminal devices in NTN systems while minimizing resource utilization imbalance issues.

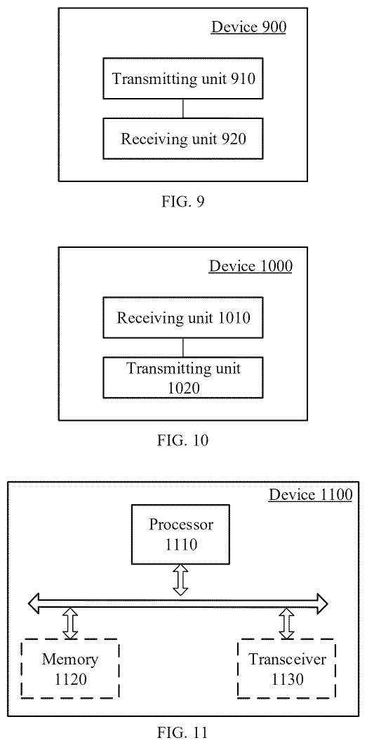

The method embodiments of the present application are described in detail above in conjunction with FIGS. 1 to 8. The device embodiments of the present application are described in detail with reference to FIGS. 9 to 11. It should be understood that the description of the embodiments of device corresponds to the description of the embodiments of method. Therefore, the parts not described in detail can refer to the previous embodiments of method.

FIG. 9 is a schematic block diagram of a device for wireless communication according to an embodiment of the present application. The device 900 may be any type of first terminal devices described above. The device 900 shown in FIG. 9 includes a transmitting unit 910 and a receiving unit 920.

The transmitting unit 910 is configured to transmit a first message on a first resource. The first message is used to request a first EDT.

The receiving unit 920 is configured to receive a feedback message of the first EDT sent by a network device. The feedback message of the first EDT includes a first RNTI. The first resource is one of multiple common PURs, the multiple common PURs correspond to multiple RNTIs including the first RNTI, and the first RNTI corresponds to the first resource or the first message includes the first RNTI.

Optionally, the device 900 further includes a first determining unit configured to determine the first RNTI based on the configuration of the network device, or to calculate the first RNTI based on the configuration of multiple common PURs.

Optionally, the first RNTI is determined based on the position of the first resource in the multiple common PURs, and/or the terminal device group to which the first terminal device belongs.

Optionally, the multiple common PURs correspond to multiple terminal device groups. When the first terminal device is terminal device j in terminal device group i, the first RNTI is given by:

$$EDT - RNTI ( i , j ) = 1 + {s}_{i d} ( i , j ) + 14 \times {t}_{i d} ( i , j ) + 14 \times M ( i ) \times {f}_{i d} ( i , j ) + 14 \times M ( i ) \times N ( i ) \times {ul}_{carrier , id} ;$$

where s_{id}(i,j) represents the index of the symbol corresponding to terminal device j in the multiple common PURs, t_{id}(i,j) represents the index of the slot corresponding to terminal device j in the multiple common PURs, f_{id}(i,j) represents the index of the frequency domain resource corresponding to terminal device j in the multiple common PURs, M(i) represents the total number of slots configured for terminal device group i, N(i) represents the total number of frequency domain resources configured for terminal device group i, and ul_{carrier,id} represents the index of the uplink carrier corresponding to the first message.

Optionally, the first terminal device is one of multiple devices requesting EDT within an NTN cell, and the first RNTI configured by the network device correlates with the terminal device group to which the first terminal device belongs. The assignment of the first terminal device to a specific terminal device group is determined based on one or more of the following information: service type of the first terminal device; service time of the first terminal device; geographic location of the first terminal device and/or sub-regions of the NTN cell.

Optionally, multiple sub-regions respectively correspond to multiple common PUR groups, the size of each common PUR group is determined based on the number of the multiple sub-regions, and/or the distance from each sub-region of the multiple sub-regions to the NTN cell edge.

Optionally, the first RNTI is determined based on one or more of the following parameters: ID of the first terminal device, C-RNTI, and TMSI.

Optionally, the configuration of multiple common PURs is applicable to the serving cell where the first terminal device is located and/or neighboring cell.

Optionally, the feedback message of the first EDT is one or more of the following: RRCEarlyDataComplete; RRCCnnectionRelease; ContentionResolution; and ACK from L1 and/or L2.

Optionally, the receiving unit 920 is further configured to receive the feedback message of the first EDT based on a first timer. The device 900 further includes a second determining unit configured to determine whether to perform a random access procedure when the feedback message indicates that the first EDT was unsuccessful.

Optionally, the feedback message of the first EDT is embedded within a group message. The group message includes feedback messages to some or all of the terminal devices in the first terminal device group requesting EDT, the some or all of the terminal devices including the first terminal device.

Optionally, the group message is carried in first MAC SDU. Reserved bits in the header of the first MAC SDU are used to indicate the service type corresponding to the first terminal device group or the ID of the sub-region where the first terminal device group is located.

Optionally, the first resource is used for some or all of the terminal devices in the first terminal device group to request EDT.

Optionally, the first message is transmitted based on the first TA value, which is pre-compensated based on one or more of the following parameters: duration of the first terminal device in idle state; last stored TA value by the first terminal device during previous TA adjustment; maximum TA pre-compensation value when the first terminal device was in previous connected state; and path loss and Doppler frequency shift when the first terminal device receives configuration information of multiple common PURs.

Optionally, the first TA value or its compensation value is: T_{delay}×T_{TA}; where T_{delay} represents the duration, and TA represents the last stored TA value by the first terminal device during previous TA adjustment.

Optionally, the first terminal device is in idle state.

Optionally, both the transmitting unit 910 and the receiving unit 920 in the device 900 may be implemented as a transceiver 1130, and the device 900 may further include a processor 1110 and a memory 1120 as specifically shown in FIG. 11.

FIG. 10 is a schematic block diagram of another device for wireless communication according to an embodiment of the present application. The device 1000 may be any type of network devices described above. The network device 1000 shown in FIG. 10 includes a receiving unit 1010 and a transmitting unit 1020.

The receiving unit 1010 is configured to receive a first message on a first resource. The first message is used by a first terminal device to request a first EDT.

The transmitting unit 1020 is configured to send a feedback message of the first EDT to the first terminal device, the feedback message of the first EDT including a first RNTI; where the first resource is one of multiple common PURs, the multiple common PURs correspond to multiple RNTIs including the first RNTI, and the first RNTI is either an RNTI corresponding to the first resource or an RNTI included in the first message.

Optionally, the device 1000 further includes a processing unit configured to configure the first RNTI for the first terminal device, or to determine the first RNTI based on the first resource.

Optionally, the first RNTI is determined based on the position of the first resource in the multiple common PURs, and/or the terminal device group to which the first terminal device belongs.

Optionally, the multiple common PURs correspond to multiple terminal device groups. When the first terminal device is terminal device j in terminal device group i, the first RNTI is given by:

$$EDT - RNTI ( i , j ) = 1 + {s}_{i d} ( i , j ) + 14 \times {t}_{i d} ( i , j ) + 14 \times M ( i ) \times {f}_{i d} ( i , j ) + 14 \times M ( i ) \times N ( i ) \times {ul}_{carrier , id} ;$$

where s_{id}(i,j) represents the index of the symbol corresponding to terminal device j in the multiple common PURs, t_{id}(i,j) represents the index of the slot corresponding to terminal device j in the multiple common PURs, f_{id}(i,j) represents the index of the frequency domain resource corresponding to terminal device j in the multiple common PURs, M(i) represents the total number of slots configured for terminal device group i, N(i) represents the total number of frequency domain resources configured for terminal device group i, and ul_{carrier,id} represents the index of the uplink carrier corresponding to the first message.

Optionally, the first terminal device is one of multiple devices requesting EDT within an NTN cell, and the first RNTI configured by the network device correlates with the terminal device group to which the first terminal device belongs. The assignment of the first terminal device to a specific terminal device group is determined based on one or more of the following information: service type of the first terminal device; service time of the first terminal device; geographic location of the first terminal device and/or sub-regions of the NTN cell.

Optionally, multiple sub-regions respectively correspond to multiple common PUR groups, the size of each common PUR group is determined based on the number of the multiple sub-regions, and/or the distance from each sub-region of the multiple sub-regions to the NTN cell edge.

Optionally, the first RNTI is determined based on one or more of the following parameters: ID of the first terminal device, C-RNTI, and TMSI.

Optionally, the configuration of multiple common PURs is applicable to the serving cell where the first terminal device is located and/or neighboring cell.

Optionally, the feedback message of the first EDT is one or more of the following: RRCEarlyDataComplete; RRCCnnectionRelease; ContentionResolution; and ACK from L1 and/or L2.

Optionally, the feedback message is used to indicate whether the first EDT is successful.

Optionally, the feedback message of the first EDT is embedded within a group message. The group message includes feedback messages to some or all of the terminal devices in the first terminal device group requesting EDT, the some or all of the terminal devices including the first terminal device.

Optionally, the group message is carried in first MAC SDU. Reserved bits in the header of the first MAC SDU are used to indicate the service type corresponding to the first terminal device group or the ID of the sub-region where the first terminal device group is located.

Optionally, the first resource is used for some or all of the terminal devices in the first terminal device group to request EDT.

Optionally, the first message is transmitted based on the first TA value, which is pre-compensated based on one or more of the following parameters: duration of the first terminal device in idle state; last stored TA value by the first terminal device during previous TA adjustment; maximum TA pre-compensation value when the first terminal device was in previous connected state; and path loss and Doppler frequency shift when the first terminal device receives configuration information of multiple common PURs.

Optionally, the first TA value or its compensation value is: T_{delay}×T_{TA}; where T_{delay} represents the duration, and TA represents the last stored TA value by the first terminal device during previous TA adjustment.

Optionally, the first terminal device is in idle state.

Optionally, both the receiving unit 1010 and the transmitting unit 1020 in the device 1000 may be implemented as a transceiver 1130, and the device 1000 may further include a processor 1110 and a memory 1120 as specifically shown in FIG. 11.

FIG. 11 is a schematic block diagram of a communication apparatus provided in an embodiment of the present application. The dashed line in FIG. 11 indicates that the unit or module is optional. The device 1100 can be configured to implement the method described in the above method embodiments. The device 1100 may be a chip, terminal device, or network device.

The device 1100 may include one or more processors 1110. The processor 1110 can support the device 1100 to implement the method described in the previous method embodiments. The processor 1110 may be a general-purpose processor or a dedicated processor. For example, the processor may be a central processing unit (CPU). Alternatively, the processor may also be other general-purpose processor, digital signal processor (DSP), application specific integrated circuits (ASIC), field programmable gate array (FPGA) or other programmable logic device, discrete gate or transistor logic device, discrete hardware component, etc. The general-purpose processor may be a microprocessor or any conventional processor.

The device 1100 may also include one or more memories 1120. The memory 1120 stores a program that can be executed by the processor 1110, enabling the processor 1110 to perform the method described in the previous method embodiments. The memory 1120 may be independent of the processor 1110 or integrated into the processor 1110.

The device 1100 may also include a transceiver 1130. The processor 1110 may communicate with other devices or chips through the transceiver 1130. For example, the processor 1110 can exchange data with other devices or chips through the transceiver 1130.

The embodiments of the present application also provide a computer-readable storage medium for storing a program. The computer-readable storage medium can be applied to the terminal or network device provided in the embodiments of the present application, and the program stored therein enables the computer to execute the method executable by the terminal or network device in the embodiments of the present application. The computer-readable storage medium can be any available medium that a computer can read, or a data storage device such as a server or data center that integrates one or more available media. The available medium may be magnetic medium (such as floppy disk, hard disk, magnetic tape), optical medium (such as digital video disc (DVD)), or semiconductor medium (such as solid state disk (SSD)).

The embodiments of the present application also provide a computer program product. The computer program product includes a program. The computer program product can be applied to the terminal or network device provided in the embodiments of the present application, and the program included therein enables the computer to execute the method executable by the terminal device or network device in the embodiments of the present application.

In the above embodiments, the functional units can be fully or partially implemented through software, hardware, firmware, or any combination thereof. When implemented using software, the units can be fully or partially implemented in the form of a computer program product. The computer program product includes one or more computer instructions. When loading and executing the computer program instructions in a computer, all or part of the processes or functions described in the embodiments of the present application are generated. The computer may be a general-purpose computer, a dedicated computer, a computer network, or other programmable device. The computer instructions may be stored in a computer-readable storage medium or transmitted from one computer-readable storage medium to another. For example, the computer instructions may be transmitted from a website site, computer, server, or data center to another website site, computer, server, or data center via wired (such as coaxial cable, fiber optic, digital subscriber line (DSL)) or wireless (such as infrared, wireless, microwave, etc.) means.

The embodiments of the present application also provide a computer program. The computer program can be applied to the terminal or network device provided in the embodiments of the present application, and enables the computer to execute the method executable by the terminal device or network device in the embodiments of the present application.

The terms “system” and “network” in the present application can be used interchangeably. In addition, the terms used in the present application are only for explaining the specific embodiments of the present application, and are not intended to limit the present application. The terms “first,” “second,” “third,” and “fourth” used in the specification, claims, and accompanying drawings of the present application are intended to distinguish different objects and not to describe a specific order. In addition, the terms “include” and “have”, as well as any variations thereof, are intended to cover nonexclusive inclusions.

In the embodiments of the present application, the term “indication” may be a direct indication, an indirect indication, or a representation of an associated relationship. For example, A indicates B, which may mean that A directly indicates B. For example, B can be obtained through A; which may also mean that A indirectly indicates B, for example, A indicates C, and B can be obtained through C; which may also mean that there is a correlation between A and B.

In the embodiments of the present application, the term “corresponding” may indicate a direct or indirect correspondence relationship between two objects, an association relationship between the two objects, or a relationship of indicating and being indicated, configuring and being configured.

In the embodiments of the present application, “being pre-defined” or “being pre-configured” can be implemented by pre-storing corresponding codes or tables in devices (for example, including terminal devices and network devices) or other ways that can be used for indicating relevant information. The specific implementation method therefor is not limited in the present application. For example, being pre-defined may refer to being defined in a protocol.

In the embodiments of the present application, determining B according to A does not mean determining B solely according to A, but mean that B can be determined according to A and/or other information.

The term “and/or” in the embodiments of the present application only describes the association relationship between related objects, indicating that there may exist three types of relationships. For example, A and/or B may cover the following three situations: A exists alone, A and B exist simultaneously, and B exists alone. In addition, the character “/” in this paper generally indicates that the related objects before and after the “/” are in an “or” relationship.

In the embodiments of the present application, the sequence numbers of the above processes do not imply the order of execution and should not constitute any limitation on the implementation process of the embodiments of the present application. The order of execution of each process should be determined by its function and internal logic.

In the several embodiments provided in the present application, it should be understood that the disclosed systems, devices, and methods can be implemented in other ways. For example, the device embodiments described above are only illustrative. For example, the division of units is only a division in accordance with logical function. In practical implementation, there may be other division methods. For example, multiple units or components may be combined or integrated into another system, or some features may be ignored or not executed. On the other hand, the mutual coupling or direct coupling or communication connection shown or discussed may be indirect coupling or communication connection through some interfaces, devices or units, which can be electrical, mechanical or in other forms.

The units described as separate components may or may not be physically separated, and the components shown as units may or may not be physical units, i.e., these components may be located in one place or distributed across multiple network units. Some or all of the units can be selected according to actual needs to achieve the purpose of the embodiments.

In addition, the functional units in various embodiments of the present application may be integrated into one processing unit, may physically exist separately, or, two or more of the functional units may be integrated into one unit.

The above only describes specific implementation of the present application, but the scope of protection of the present application is not limited thereto. Any skilled person familiar with the technical field can easily conceive changes or replacements within the technical scope disclosed by the present application. These changes or replacements should be covered in the scope of protection of the present application. Therefore, the scope of protection of the present application shall be subject to the scope of protection of the appended claims.

What is claimed is:

1. A wireless communication method, comprising:
transmitting, by a first terminal device in a non-terrestrial network (NTN) cell, a first early data transmission (EDT) on a first resource; and
receiving, by the first terminal device, a feedback message of the first EDT from a network device, the feedback message of the first EDT including a first radio network temporary identifier (RNTI),
wherein the first resource is one of a plurality of common preconfigured uplink resources (PUR), the plurality of common PURs correspond to a plurality of RNTIs including the first RNTI, and the first RNTI corresponds to the first resource or the first EDT includes the first RNTI.

2. The method according to claim 1, further comprising:
determining the first RNTI based on configuration of the network device; or
calculating the first RNTI based on configuration of the plurality of common PURs.

3. The method according to claim 1, wherein the first RNTI is determined based on at least one of a position of the first resource in the plurality of common PURs, or a terminal device group to which the first terminal device belongs.

4. The method according to claim 3, wherein the plurality of common PURs correspond to a plurality of terminal device groups, and when the first terminal device is terminal device j in terminal device group i, the first RNTI is given by:
$$EDT - RNTI ( i , j ) = 1 + {s}_{i d} ( i , j ) + 14 \times {t}_{i d} ( i , j ) + 14 \times M ( i ) \times {f}_{i d} ( i , j ) + 14 \times M ( i ) \times N ( i ) \times {ul}_{carrier , id} ;$$
wherein s_{id}(i,j) represents an index of symbol corresponding to terminal device j in the plurality of common PURs, t_{id}(i,j) represents an index of slot corresponding to terminal device j in the plurality of common PURs, f_{id}(i,j) represents an index of frequency domain resource corresponding to terminal device j in the plurality of common PURs, M(i) represents a total number of slots of terminal device group i, N(i) represents a total number of frequency domain resources of terminal device group i, and ul_{carrier,id} represents an index of uplink carrier corresponding to the first EDT.

5. The method according to claim 3, wherein the first terminal device is one of a plurality of devices requesting EDT within the NTN cell, and the first RNTI configured by the network device correlates with the terminal device group to which the first terminal device belongs, and wherein the terminal device group to which the first terminal device belongs is determined based on one or more of:
service type of the first terminal device;
service time of the first terminal device;
geographic location of the first terminal device; or
a plurality of sub-regions of the NTN cell.

6. The method according to claim 5, wherein the plurality of sub-regions respectively correspond to a plurality of common PUR groups, a size of each common PUR group of the plurality of common PUR groups is determined based on at least one of a number of the plurality of sub-regions, or a distance from each sub-region of the plurality of sub-regions to an NTN cell edge.

7. The method according to claim 1, wherein the first RNTI is determined based on one or more of: ID of the first terminal device, cell RNTI (C-RNTI), and temporary mobile subscription identifier (TMSI).

8. The method according to claim 1, wherein configuration of the plurality of common PURs is applicable to at least one of a serving cell where the first terminal device is located or a neighboring cell.

9. The method according to claim 1, wherein the feedback message of the first EDT is one or more of:
RRCEarlyDataComplete;
RRCCnnectionRelease;
ContentionResolution; or
at least one of ACK from layer 1 (L1) or layer 2 (L2).

10. The method according to claim 1, further comprising:
receiving the feedback message of the first EDT based on a first timer; and
determining whether to perform a random access procedure in response to the feedback message indicating that the first EDT is unsuccessful.

11. The method according to claim 1, wherein the feedback message of the first EDT is embedded within a group message, and wherein the group message includes feedback messages to some or all of terminal devices in a first terminal device group requesting EDT, the some or all of terminal devices including the first terminal device.

12. The method according to claim 11, wherein the group message is carried in a first media access control (MAC) service data unit (SDU), and wherein reserved bits in header of the first MAC SDU indicate a service type corresponding to the first terminal device group or ID of a sub-region where the first terminal device group is located.

13. The method according to claim 11, wherein the first resource is used for some or all of terminal devices in the first terminal device group to request EDT.

14. The method according to claim 1, wherein the first EDT is transmitted based on a first TA value, and wherein the first TA value is pre-compensated based on one or more of:
duration of the first terminal device in idle state;
last stored TA value by the first terminal device during previous TA adjustment;
maximum TA pre-compensation value when the first terminal device was in previous connected state; or
path loss and Doppler frequency shift when the first terminal device receives configuration information of the plurality of common PURs.

15. The method according to claim 14, wherein the first TA value or its compensation value is:
$${T}_{delay} \times {T}_{TA} ;$$
wherein T_{delay} represents the duration, and T_{TA} represents the last stored TA value by the first terminal device during the previous TA adjustment.

16. The method according to claim 1, wherein the first terminal device is in idle state.

17. A wireless communication method, comprising:
receiving, by a network device in a non-terrestrial network (NTN) cell, a first early data transmission (EDT) on a first resource; and
sending, by the network device, a feedback message of the first EDT to a first terminal device, the feedback message of the first EDT including a first RNTI,
wherein the first resource is one of a plurality of common PURs, the plurality of common PURs correspond to a plurality of RNTIs including the first RNTI, and the first RNTI corresponds to the first resource or the first EDT includes the first RNTI.

18. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
transmitting, while in a non-terrestrial network (NTN) cell, a first early data transmission (EDT) on a first resource; and
receiving a feedback message of the first EDT from a network device, the feedback message of the first EDT including a first radio network temporary identifier (RNTI), wherein the first resource is one of a plurality of common preconfigured uplink resources (PUR), the plurality of common PURs correspond to a plurality of RNTIs including the first RNTI, and the first RNTI corresponds to the first resource or the first EDT includes the first RNTI.

19. The apparatus according to claim 18, the operations further comprising:
determining the first RNTI based on configuration of the network device; or
calculating the first RNTI based on configuration of the plurality of common PURs.

20. The apparatus according to claim 18, wherein the first RNTI is determined based on at least one of a position of the first resource in the plurality of common PURs, or a terminal device group.
